(19) United States
(12) Patent Application Publication
(10) Pub. No.: US 2024/0320065 A1
(43) Pub. Date: Sep. 26, 2024

(54) SYSTEM TO GENERATE EVENT RECORDS FOR ONBOARDING REQUESTS

(71) Applicants: Garry Jean Theus, Manchester, CT (US); Pamela J. Beneke, Riverton, CT (US); Glenn Goodrich, Newington, CT (US); Jennifer B. Horn, South Windsor, CT (US); Eric P Kulatilake, Burlington, CT (US); Maria McClelland, Minneola, FL (US); Nancy J. Sullivan, Ellington, CT (US); Gregory Adam Wyche, Amston, CT (US)

(72) Inventors: Garry Jean Theus, Manchester, CT (US); Pamela J. Beneke, Riverton, CT (US); Glenn Goodrich, Newington, CT (US); Jennifer B. Horn, South Windsor, CT (US); Eric P Kulatilake, Burlington, CT (US); Maria McClelland, Minneola, FL (US); Nancy J. Sullivan, Ellington, CT (US); Gregory Adam Wyche, Amston, CT (US)

(21) Appl. No.: 18/188,184

(22) Filed: Mar. 22, 2023

(51) Int. Cl. G06F 9/54; G06F 16/21

(52) U.S. Cl. CPC G06F 9/542; G06F 16/211

(57) ABSTRACT

According to some embodiments, systems and methods are provided including a plurality of internal data systems; a plurality of external data systems; a back-end application computer server, coupled to the plurality of internal data systems and the plurality of external data systems, the back-end application computer server including: a computer processor, and a computer memory, coupled to the computer processor, storing instructions that, when executed by the computer processor, cause the back-end application computer server to: receive an event onboarding request; receive selection of a first external data system of the plurality of external data systems and an event type; and generate an event record based on the selected first external data system and the event type. Numerous other aspects are provided.

### BACKGROUND

A primary organization may use one or more external organizations to provide external software for the primary organization. For example, the external software provided by the external organization(s) may include solutions for human capital management, planning, human resources, employee benefits, etc. The primary organization may also enter into a relationship with a secondary organization which is different from the external organization. The secondary organization may include one or more internal software systems that may exchange data with the external organizations on behalf of the primary organization. However, each internal system may need to independently handle the setup and configuration of the transfer of data between itself and the external software. The independent setup and configuration is a time consuming and cumbersome process that may be prone to errors.

Systems and methods are desired which support more efficient connection between the external software and the internal software on behalf of the primary organization.

### SUMMARY OF THE INVENTION

According to some embodiments, systems, methods, computer program code and means are provided for onboarding external platforms to a central platform and providing data exchange capabilities that permit faster more efficient results as compared to traditional approaches. In some embodiments, a system may provide a plurality of internal data systems, a plurality of external data systems and a back-end application computer server. The back-end application computer server may be coupled to the plurality of internal data systems and the plurality of external data systems. The back-end application computer server may include a computer processor and a computer memory. The computer memory may be coupled to the computer processor. The computer memory stores instructions executable by the computer processor. An event onboarding request is received by the back-end application computer server. The back-end application computer server then receives selection of a first external data system of the plurality of external data systems and an event type. An event record is generated by the back-end application computer server based on the selected first external data system and the event type.

Some embodiments comprise a process including receiving, from a remote user device, an event onboarding request; receiving, by a computer processor of a back-end application computer server, selection of a first external data system of a plurality of external data systems and an event type; and generating, by the computer processor of the back-end application computer server, an event record based on the selected first external data system and the event type.

Embodiments comprise a non-transitory, computer-readable medium storing instructions executable by a processor. Execution of the instructions causes the processor to receive an event onboarding request; receive selection of a first external data system of a plurality of external data systems and an event type; and generate an event record based on the selected first external data system and the event type.

A technical effect of some embodiments of the invention is an improved and computerized way to set up and exchange data between internal and external systems in a way that provides faster, more efficient results as compared to traditional approaches. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram according to some embodiments.

FIG. 2 is a block diagram of a conventional system.

FIG. 3 is a block diagram including a connection platform according to some embodiments.

FIG. 4 is a block diagram of a system architecture according to some embodiments.

FIG. 5 is an outward view of a graphical user interface according to some embodiments.

FIG. 6 is a flow diagram of a process according to some embodiments.

FIG. 7 is an outward view of a graphical user interface according to some embodiments.

FIG. 8 is an outward view of a graphical user interface according to some embodiments.

FIG. 9 is a flow diagram of a process according to some embodiments.

FIG. 10 is an outward view of a graphical user interface according to some embodiments.

FIG. 11 is an outward view of a graphical user interface according to some embodiments.

FIG. 12 is an outward view of a graphical user interface according to some embodiments.

FIG. 13 is a flow diagram of a process according to some embodiments.

FIG. 14 is an outward view of a graphical user interface according to some embodiments.

FIG. 15 is an outward view of a graphical user interface according to some embodiments.

FIG. 16 is an outward view of a graphical user interface according to some embodiments.

FIG. 17 is a flow diagram of a process according to some embodiments.

FIG. 18 is an outward view of a graphical user interface according to some embodiments.

FIG. 19 is a flow diagram of a process according to some embodiments.

FIG. 20 is an outward view of a graphical user interface according to some embodiments.

FIG. 21. is an outward view of a graphical user interface according to some embodiments.

FIG. 22 is an outward view of a graphical user interface according to some embodiments.

FIG. 23 is an outward view of a graphical user interface according to some embodiments.

FIG. 24 is an outward view of a graphical user interface according to some embodiments.

FIG. 25 is an outward view of a graphical user interface according to some embodiments.

FIG. 26 is an outward view of a graphical user interface according to some embodiments.

FIG. 27 is an outward view of a graphical user interface according to some embodiments.

FIG. 28 is an outward view of a graphical user interface according to some embodiments.

FIG. 29 is an outward view of a graphical user interface according to some embodiments.

FIG. 30 is a flow diagram of a process according to some embodiments.

FIG. 31 is a block diagram of a system architecture according to some embodiments.

FIG. 32 is a block diagram of a system architecture according to some embodiments.

FIG. 33 is a flow diagram of a process according to some embodiments.

FIG. 34 is a block diagram of a system according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate electronic data exchange and processing between a secondary and tertiary party on behalf of a primary party. The present invention is directed to more than merely a computer implementation of a routine or conventional activity previously known in the industry as it significantly advances the technical efficiency, access, and/or accuracy of communications between devices by implementing a specific new method and system as defined herein. The present invention is a specific advancement in the area of electronic data exchange by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized systems, networks, and subsystems. For example, in the present invention information may be processed, updated, and analyzed via a back-end-end application server to accurately improve the analysis and/or the exchange of information, thus improving the overall efficiency of the system associated with message storage requirements and/or bandwidth considerations (e.g., by reducing the number of messages that need to be transmitted via a network).

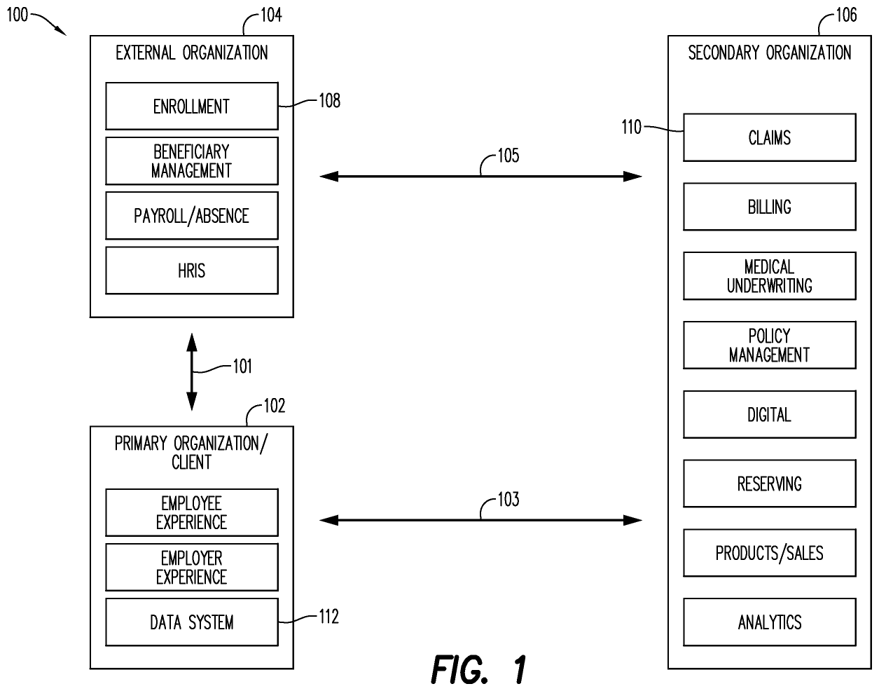

FIG. 1 is a high-level block diagram of a system 100 including a primary organization 102, an external organization 104 and a secondary organization 106. The primary organization 102, which may also be referred to as the “client” herein, may be any suitable organization employing one or more employees. The primary organization 102 may access/use software (external data software system 108) provided by one or more external organizations 104 to execute one or more functions associated with operating the primary organization 102, such that the primary organization 102 and the external organization 104 exchange data 101 therebetween. In some embodiments, the external organization 104 may be a third-party company that owns a Human Capital Management Platform including one or more external data software systems 108 used in the enrollment, beneficiary management, payroll/absence, Human Resource Information Systems (HRIS), etc. of the employees of the primary organization 102. The external data system 108 may be any other suitable external data system. As used herein, the external organization 104 may be referred to as a “Tech Partner”. Non-exhaustive examples of the external organizations include Workday®, Selerix®, ADPR, Oracle®, Ultimate Software®, etc.

In some embodiments, the primary organization 102 may enter into a relationship with a secondary organization 106 which is different from the external organization 104. The secondary organization 106 may include one or more internal data software systems 110 that may exchange data 103 with the primary organization 102 and may exchange data 105 with the external organizations 104 on behalf of the primary organization 102. Non-exhaustive examples of internal data systems 110 include claims, billing, medical underwriting, policy management, digital, reserving, products/sales, and analytics. The internal data systems 110 may access data in the external data systems 108 on behalf of the primary organization 102.

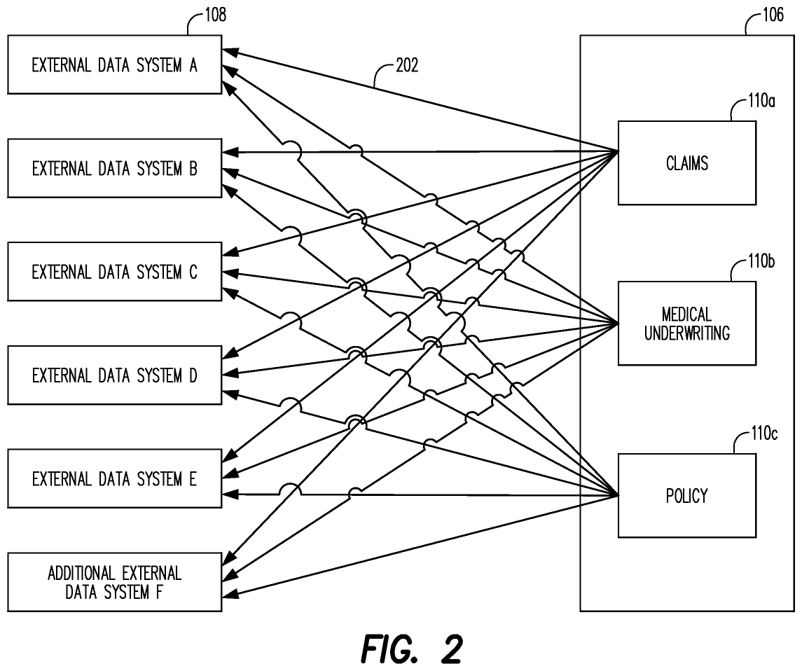

For example, as shown in FIG. 2, conventionally, each of the internal data systems 110a-c may access each of the external data systems 108A-F via connections 202. Conventionally, to access data in each of the external data systems 108, each individual internal data system 110 may independently handle primary/external organization configuration management, data transformation, data validation, message delivery (including fault tolerance), logging/auditing and security with external organizations. Further, the secondary organization 106 may be updated to establish each new external organization connection. It is noted that the plurality of point-to-point connections 202 may result in high maintenance and support costs.

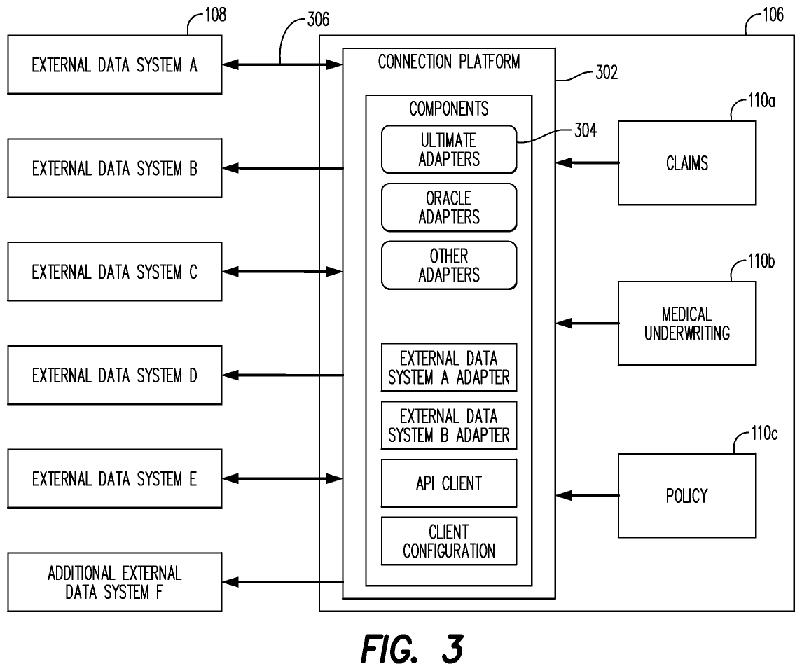

According to some embodiments, the secondary organization 106 may include a connection platform 302, as shown in FIG. 3. The connection platform 302 may connect the individual internal data systems 110 to the external data systems 108 using near-real time Application Programming Interfaces (APIs). The connection platform 302 may include a plurality of adapters 304, as described further below, to transform data format such that the data may be exchanged between the internal data systems 110 and external data systems 108, and used thereby. In some embodiments, the adapters 304 may be reusable across both a plurality of primary organizations and external organizations. The connection platform 302 may provide for a configuration-driven primary organization onboarding to access the internal data systems, as well as for the internal data systems to access data of the primary organization per the external data systems. As used herein, “onboarding” may refer to the integration of data systems so that the connection platform may be implemented and integrated into a typical workflow. The connection platform 302 may also insulate the internal data systems 110 from the external organizations and vice versa. Continuing with the non-exhaustive examples of internal data systems 110, the connection platform 302 may provide for: the delivery of claim data updates from a claims internal data system; the delivery of Evidence of Insurability (EOI) decision status changes to records of external data systems; the receipt of eligibility member data from external data systems; the receipt of data from employee data records from external data systems; the delivery of data validation results to external data systems; the delivery of plan design (i.e., policy) data to external enrollment platforms; and the delivery of billing data to primary organizations.

As such, the connection platform 302 may remove the need for each internal data system 110 to handle primary/external organization configuration management, data transformation, data validation, message delivery (including fault tolerance), logging/auditing and security with external organizations. Centralizing the access via the connection platform 302 results in lower maintenance and support costs, as indicated by lesser connections 306 in FIG. 3 as compared to the point-to-point connections 202 in FIG. 2, connecting the same internal data systems 110 and external data systems 108. For example, in FIG. 3, each external data system is only connected to the secondary organization/internal data system at a single point.

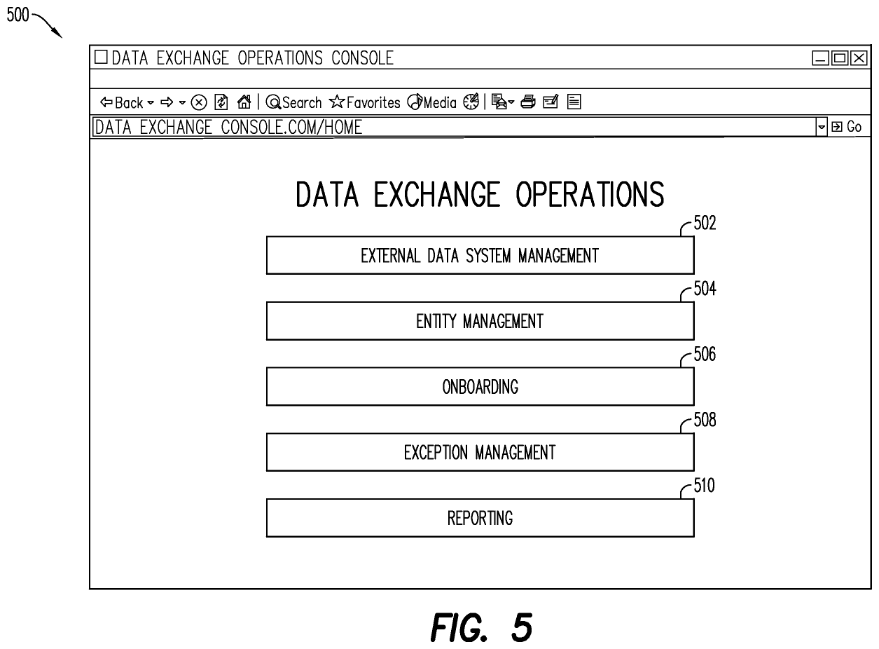

By virtue of some embodiments, the external organization 104 and primary organizations 102 may directly onboard their external data systems 108 and primary data systems 112, respectively, with the connection platform 302 via a connection platform user interface for new data exchange capabilities 500 (FIG. 5) as described further below. The direct onboarding may reduce the time frame for the set-up/configuration of each organization, as compared to previous onboarding methods including the submission of onboard tickets to an Information Technology (IT) group. In particular, direct onboarding may eliminate IT tickets to complete the onboarding task and the extended turn-around time for completion of a ticket, thereby reducing the number of messages that need to be transmitted via a network, resulting in an increase in available bandwidth. As a non-exhaustive example, completion of a ticket may take 3-5 days per client per function, which for 47 clients, for example, is 188 days (47×4 day average) of wait time per function. The direct onboarding may also eliminate the dependency on a connection platform development assistance and support team. The connection platform 302 may also directly support the external organization and primary organization via the functions provided by the internal data systems.

The connection platform user interface 500 may, according to embodiments, also provide for the secondary organization to troubleshoot and review errors as part of testing and ongoing maintenance of the external organization and primary organization. The use of the connection platform user interface 500 may reduce error tickets and research time for support staff by providing a user interface that allows the support staff to handle the error tickets themselves. For example, the connection platform user interface 500 may provide access to original transactional data received/sent to support the executed functions (e.g., claims and client inquiries). The inventors note it may be important during testing of the onboarding process for each client/organization to have timely turn-around feedback.

In one or more embodiments, the connection platform user interface may provide reporting capabilities. For example, the reporting may provide: status and counts of external organization and primary organizations by capability; census reporting of inbound transactional data to support customer relationship management (CRM) and sales; and reconcile data received/sent.

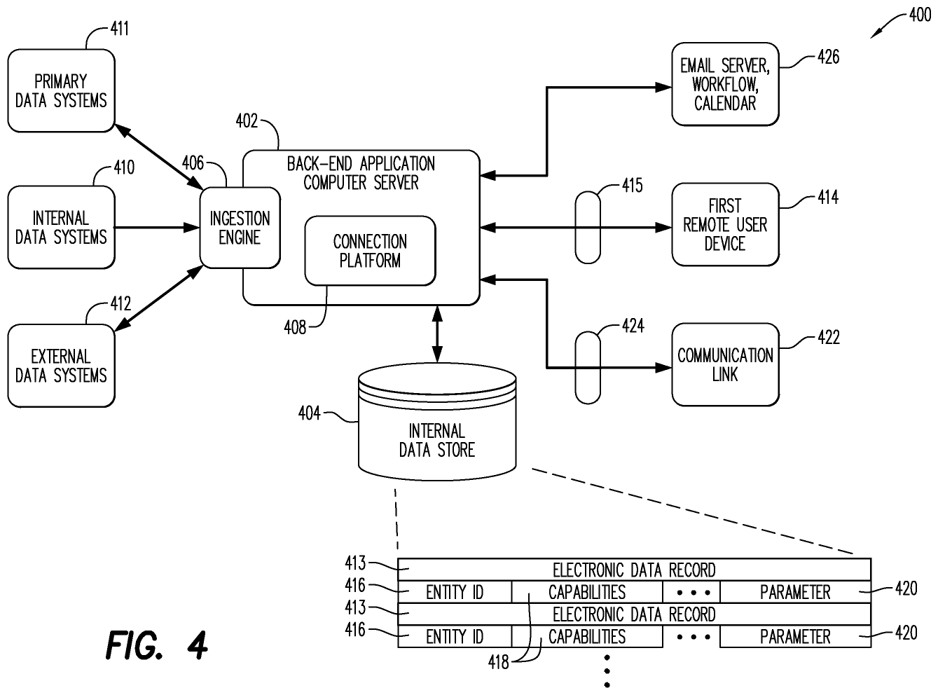

FIG. 4 is a high-level block diagram of architecture 400 according to some embodiments. The illustrated elements of architecture 400 and of all other architecture depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of architecture 400 are implemented by a single computing device, and/or two or more elements of architecture 400 are co-located. One or more elements of architecture 400 may be implemented using cloud-based resources, and/or other systems which apportion computing resources elastically according to demand, need, price, and/or any other metric.

Architecture 400 includes a back-end application computer server 402 that may access information in an internal data store 404 (e.g., storing a set of electronic records 413 associated with primary data system 411 of primary organization 102 and external data systems 412 of external organizations, etc., each record including, for example, one or more identifiers 416, operational data/capabilities 418, parameters 420, etc.). The back-end application computer server 402 may also store information into other suitable data stores, and may utilize an ingestion engine 406 and a connection platform 408 to: exchange data with internal data systems 410, primary data system 411, and external data systems 412; process data; and view, analyze and/or update the electronic records. The connection platform 408 may be a cloud-based platform and may provide any suitable interfaces through which the users may communicate with the data system. The connection platform 408 may provide for the chaining of data across the different data systems. The connection platform 408 may also support scaling for a large number of executions of data systems on the cloud platform.

The back-end application computer server 402 may also exchange information with a first remote user device 414 (e.g., via a firewall 415). The back-end application computer server 402 may also exchange information via communication links 422 (e.g., via communication port 424 that may include a firewall) to communicate with different systems. The back-end application computer server 402 may also transmit information directly to an email server, workflow application, and/or calendar application 426 to facilitate automated communications and/or other actions.

According to some embodiments, an interactive graphical user interface platform of the back-end application computer server 402 (and, in some cases, data from the internal and external systems) may facilitate resolutions, workflow recommendations, alerts, and/or the display of results via one or more remote user devices 414. For example, the first remote user device 414 may transmit new, annotated and/or updated information to the back-end application computer server 402. Based on the transmitted information, the back-end application computer server 402 may send data to and/or receive data from the internal data system 410 and external data system 412 via the connection platform 408 and may adjust data in the internal data store 404.

The back-end application computer server 402 and/or the other elements of the system 400 may be, for example, associated with a Personal Computer (“PC”), laptop computer, smartphone, an enterprise server, a server farm, and/or a database or similar storage devices. According to some embodiments, an “automated” back-end application computer server 402 (and/or other elements of the system 400) may facilitate the automated access and/or update of electronic records in the data store 404. As used herein, the term “automated” may refer to, for example, actions that can be performed with little (or no) intervention by a human.

The back-end application computer server 402 may provide any suitable interfaces through which users may communicate with the connection platform 408 and/or applications executing thereon. The back-end application computer server 402 may include a Hyper Text Transfer Protocol (HTTP) interface supporting a transient request/response protocol over Transmission Control Protocol/Internet Protocol (TCP/IP), a WebSocket interface supporting non-transient full-duplex communications which implement the WebSocket protocol over a single TCP/IP connection, and/or an Open Data Protocol (OData) interface.

As used herein, devices, including those associated with the back-end application computer server 402 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 402 may store information into and/or retrieve information from at least one of the internal data store 404, the internal data systems 410, external data systems 412, and primary data system 411. The data stores 404 may be locally stored or reside remote from the back-end application computer server 402. As will be described further below, the internal data store 404 may be used by the back-end application computer server 402 in connection with an interactive user interface to access and update electronic records, as well as perform other tasks. Although a single back-end application computer server 402 is shown in FIG. 4, any number of such devices may be included. Moreover, various devices described herein may be combined according to embodiments of the present invention. For example, in some embodiments, the back-end application computer server 402 and internal data store 404 may be co-located and/or may comprise a single apparatus.

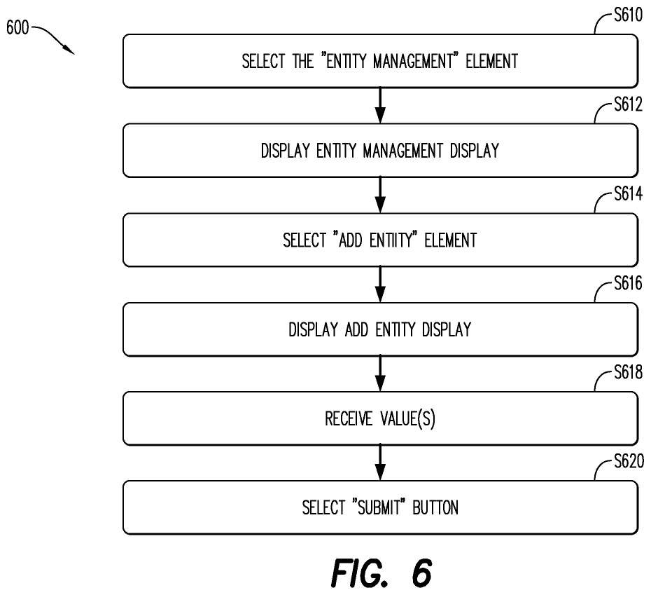

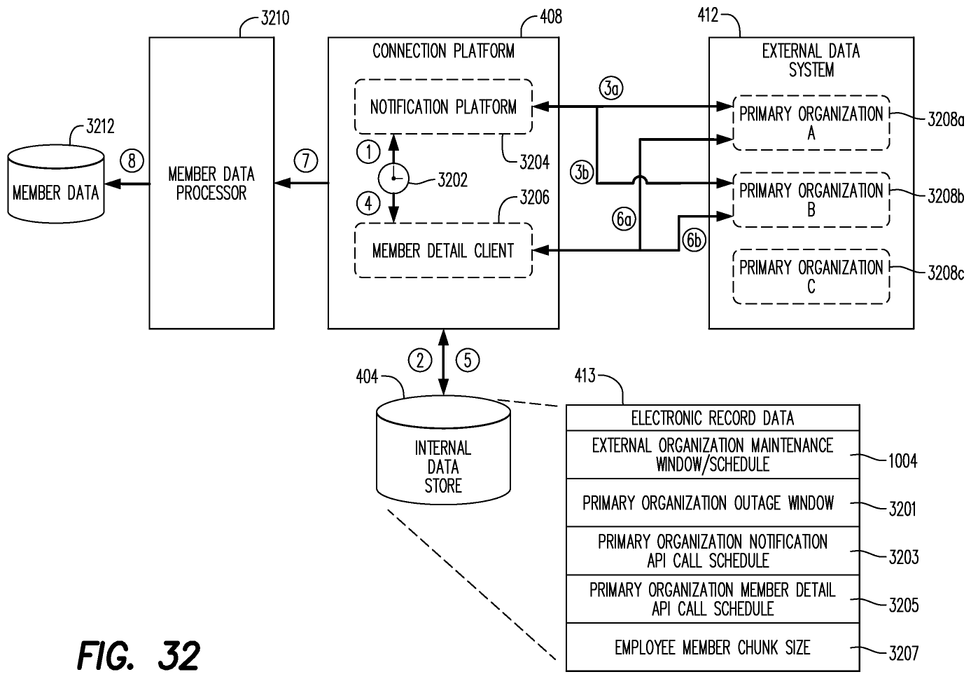

FIGS. 6, 9, 13, 17, 19 and 30 illustrate a process 600 of onboarding an entity/client/primary organization; a process 900 of onboarding an external data system; a process 1300 of configuring a maintenance outage schedule; a process 1700 of updating a maintenance outage schedule; a process 1900 to onboard an event; and a process 3000 to exchange data, respectively, in accordance with an example embodiments. The respective processes may be described with respect to block diagrams and an outward view of user interfaces according to some embodiments. Process 600, 900, 1300, 1700, 1900 and 3000 may be executed by application server 402/3230 according to some embodiments, e.g., by execution of the connection platform 408. In one or more embodiments, the application server 402/3230, database node, computing system (user device), a combination of devices/nodes, or the like may be conditioned to perform the process 600, 900, 1300, 1700, 1900 and 3000 according to embodiments. In one or more embodiments, the application server 402/3230 may be conditioned to perform the process 600, 900, 1300, 1700, 1900 and 3000, such that a processor 3210 (FIG. 32) of the server 402/3230/system 400/3100/3200 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

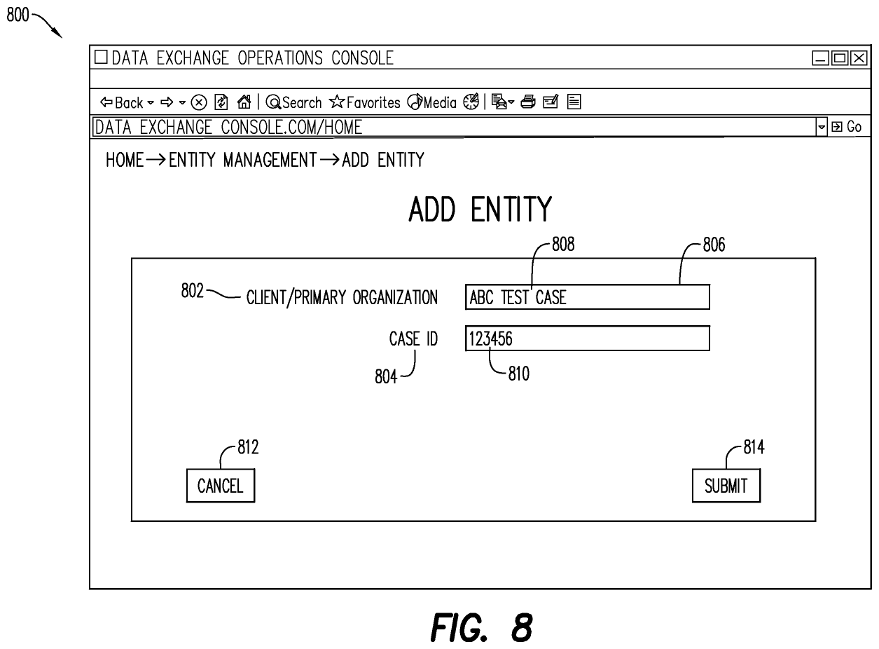

User interface 500, 800, 1000, 1100, 1200, 1400, 1500, 1600, 1800, 2000, 2100, 2600, 2900, may be presented on any type of display apparatus (e.g., desktop monitor, smartphone display, tablet display) provided by any type of client device (e.g., desktop system, smartphone, tablet computer). The application which is executed to provide user interface 500, 800, 1000, 1100, 1200, 1400, 1500, 1600, 1800, 2000, 2100, 2600, 2900 may comprise a Web Browser, a standalone application, or any other application. Embodiments are not limited to user interface 500, 800, 1000, 1100, 1200, 1400, 1500, 1600, 1800, 2000, 2100, 2600, 2900 of FIGS. 5, 8, 10, 11, 12, 14, 15, 16, 18, 20, 21, 26, 27, 28 and 29.

The set-up of the primary organization 102 and external organization 104 with the connection platform 408 may be executed via a Graphical User Interface (“GUI”). For example, FIG. 5 is a Data Exchange Operations console or display 500 including graphical representations of elements of the connection platform 408 according to some embodiments. Selection of a portion or element of the display 500 via a touchscreen or pointer may result in the presentation of additional information about that portion or element (e.g., a popup window presenting a data source or take the user to another screen) or let an operator enter or annotate additional information. A non-exhaustive example of the Data Exchange Operations console 500 may include an External Data System Management element 502, an Entity Management element 504, an Onboarding element 506, an Exception Management element 508 and a Reporting element 510. Other suitable elements may be included.

Selection of the External Data System Management element 502 may provide for the set-up and management of an external organization and their external data systems with the connection platform 408, as will be described further below.

Selection of the Entity Management element 504 may provide for the set-up and management of an entity/client/primary organization with the connection platform 408, as will be described further below.

Selection of the Onboarding element 506 may provide for the set-up and management of events that may include the exchange of data between the primary organization, secondary organization, and external organization via the connection platform 408.

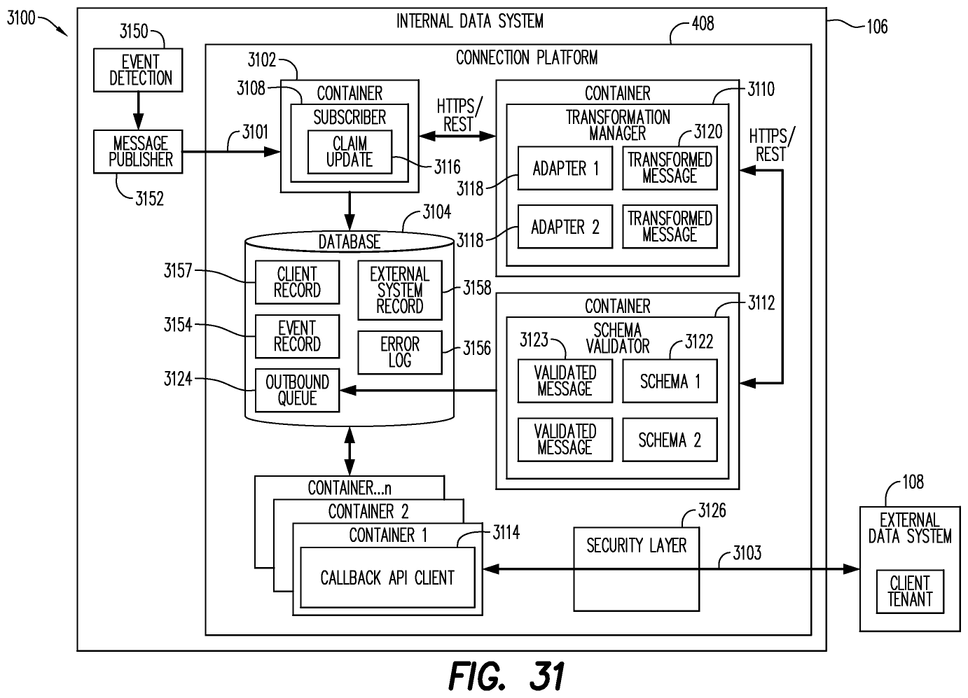

Selection of the Exception Management element 508 may provide for the management of errors detected during the set-up and management of the events. As may be described further below, as a non-exhaustive example, in a case that a transmitted message/event is not properly formatted, the message may be written to an error log 3156 in a database of the connection platform 408. A log entry may be created for the error in an error log and an email may be sent to an appropriate user to indicate that this record failed validation. The user may then access the error log 3156 (FIG. 31) via selection of the Exception Management element 508.

Selection of the Reporting element 510 may provide for the management and creation of reports regarding parameters associated with the different events. As a non-exhaustive example, the reports may be associated with a volume of events that have occurred within a particular window of time.

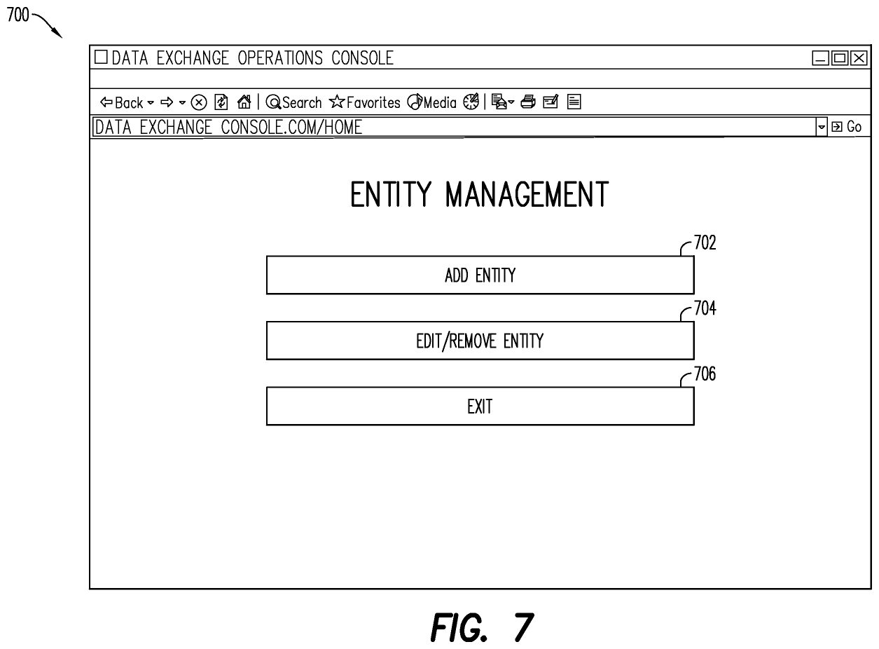

FIG. 6 provides a process 600 to set-up an entity/client/primary organization 102 with the connection platform 408 so that the primary data system 112 of entity/client/primary organization 102 may exchange data with the connection platform 408, and have data exchanged on its behalf. Initially, at S610 a user may select the “Entity Management” element 504 from the Data Exchange Operations display 500. Selection of the “Entity Management” element 504 may result in the display of an Entity Management display 700 (FIG. 7) in S612. The Entity Management display 700 may include one or more selectable elements including, but not limited to an “Add Entity” element 702, an “Edit/Remove Entity” element 704 and an “Exit” element 706. Next in S614, the “Add Entity” element 702 is selected. Selection of the “Add Entity” element 702 may result in the display of the Add Entity display 800 in S616. The Add Entity display 800 may include a Client/Primary Organization parameter 802 and a Case ID parameter 804. Each parameter may have a user entry field 806 associated therewith, where the user entry field 806 may receive a value 808/810, respectively, to describe the entity. In S618 one or more values are received in the user entry field(s). Here, the Client/Primary Organization value 808 is “ABC Test Case” and the Case ID value 810 is “123456”. As will be appreciated, here and in the other user interfaces described herein, rather than using a text/data-entry field to input a value, the user interface may include a drop down, calendar or other menu with selectable values.

In one or more embodiments, set-up of the entity/client/primary organization 102 may also include at least one of a primary organization outage window 3201 (FIG. 32), a primary organization notification API call schedule 3203 (FIG. 32), a primary organization member (e.g., employee) detail API call schedule 3205 (FIG. 32) and an employee member chunk size 3207 (FIG. 32). This data may also be stored in the internal data store 404.

The primary organization outage window 3201 may be a period of time for an outage when the primary organization will be unavailable for data exchange via their tenant or may have a reduction in service in order to accommodate system upgrades, preventative maintenance or other suitable maintenance. The primary organization outage window 3201 may prevent the connection platform from calling their external organization tenant 3208, described further below, when the external organization is executing a long running process (e.g., Payroll) to avoid errors in that process and prolonging of the process.

The primary organization notification API call schedule 3203 may be pre-set times the primary organization may receive API calls from a notification client 3204 (FIG. 32) of the connection platform to receive one or more employee identifiers of a corresponding data record where a change has occurred.

The primary organization member detail API call schedule 3205 may be pre-set times the primary organization may receive API calls from the connection platform to receive further data regarding the records that have changed.

The employee member chunk size 3207 is a pre-defined subset of members for which a change has occurred and for which the updated information may be transmitted to other systems at a time. For example, if 18,000 employees have received an update, the employee member chunk size may be fifty, such that the updates for fifty of the 18,000 is transmitted at a time to provide smaller payloads and thereby avoid a connection timeout failure.

The Add Entity display 800 may also include a “Cancel” button 812 and a “Submit” button 814. To exit the display without saving the entered text, the user may select the “Cancel” button 812. To save the entered text to the internal data store 404, the user may select the “Submit” button 814 and a client record 3157 is stored (FIG. 31). In S620, the “Submit” button is selected.

Selection of either the “Cancel” button 812 or the “Submit” button 814 may result in the navigation back to the Data Exchange Operations display 500, with the data first being saved to the internal data sore in the case of selection of the “Submit” button 814.

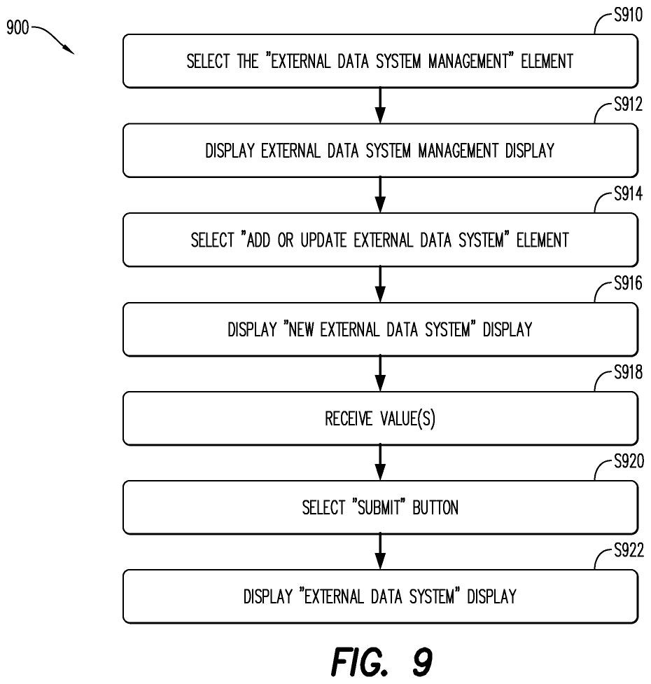

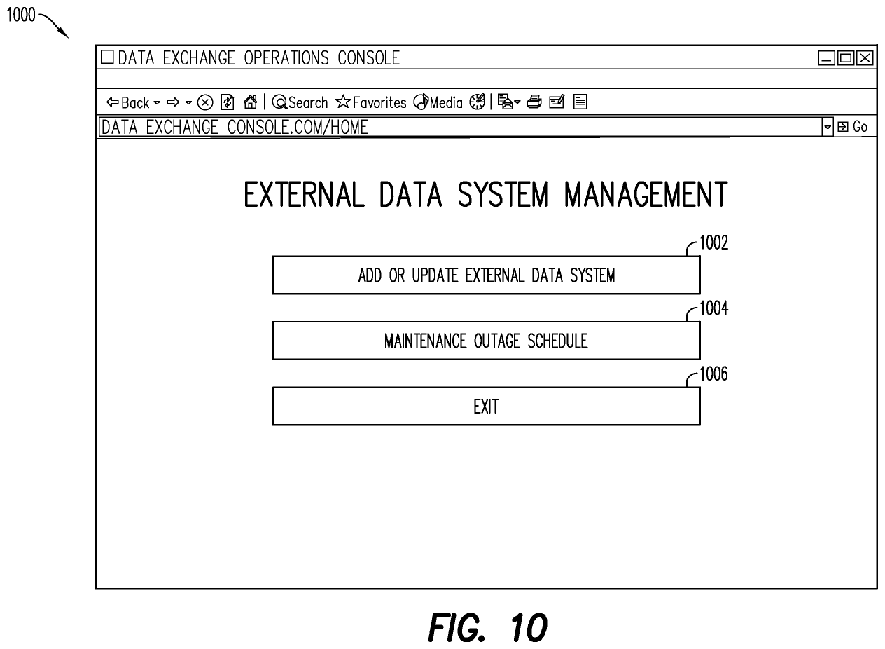

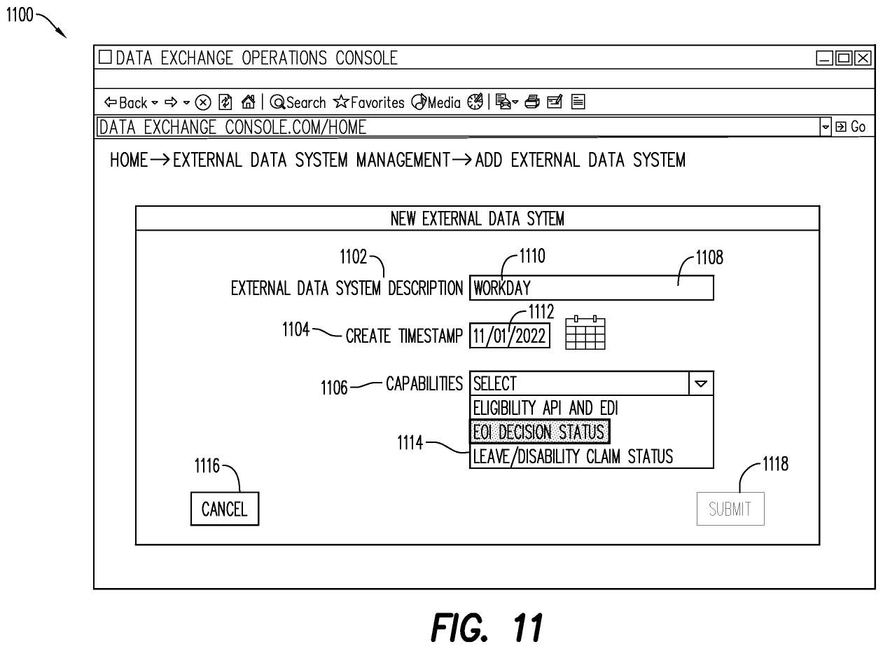

FIG. 9 provides a process 900 to set-up an external data system 108 of an external organization 104 with the connection platform 408 so that the external data system 108 may exchange data with the connection platform 408. Initially, at S910 a user may select the “External Data System Management” element 502 from the Data Exchange Operations display 500. Selection of the “External Data System Management” element 502 may result in the display of an External Data System Management display 1000 (FIG. 10) in S912. The External Data System Management display 1000 may include an “Add or Update External Data System” element 1002, a “Maintenance Outage Schedule” element 1004 and an “Exit” element 1006. In some embodiments, selection of the “Exit” element 1006 may return the user to the Data Exchange Operations display 500. Other suitable selectable elements may be included. Next, at S914, the “Add or Update External Data System” element 1002 is selected. Selection of the “Add or Update External Data System” element 1002 may result in the display of a “New External Data System” display 1100 (FIG. 11) in S916. The “New External Data System” display 1100 may include an External Data System Description parameter 1102, a Create Timestamp parameter 1104 and a Capabilities parameter 1106. Each parameter may have a user entry field 1108 associated therewith, where the user entry field 1108 may receive a value 1110/1112/1114, respectively, to describe the parameter. The External Data System Description parameter 1102 may include the name of the External Data System. The Create Timestamp parameter 1104 may define the date on which the External Data System was added. It is noted that in some embodiments, in addition to, or instead of, the Create Timestamp parameter 1104, the display 1100 may include an effective date parameter indicative of the date on which the External Data System may be accessible via the connection platform 408. As a non-exhaustive example, the External Data System may be added on Jun. 1, 2023, but may not be accessible until Jun. 15, 2023. The Capabilities parameter 1106 may define the function provided by the External Data System. As a non-exhaustive example, an ADP® External Data System may provide a payroll capability. In S918 one or more values are received in the user entry field(s) 1108. Here the External Data System Description value 1110 is “Workday” and the Create Timestamp value 1112 is “Nov. 1, 2022.” The selectable values for the Capability parameter 1106 are Eligibility API and Electronic Data Interchange (EDI), EOI Decision Status (“Health status”) and Leave/Disability Claim Status. Here, the selected Capability value 1114 is “EOI Decision Status” as indicated by the value being highlighted. In some embodiments, the available selectable values may be populated based on the entered External Data System, as only functions that may be provided by the indicated External Data System are available for selection.

The “New External Data System” display 1100 may also include a “Cancel” button 1116 and a “Submit” button 1118. To exit the display without saving the entered text, the user may select the “Cancel” button 1116. To save the entered text to the internal data store 404, the user may select the “Submit” button 1118 and an external data system record 3158 (FIG. 31) is stored. In S920, the “Submit” button is selected.

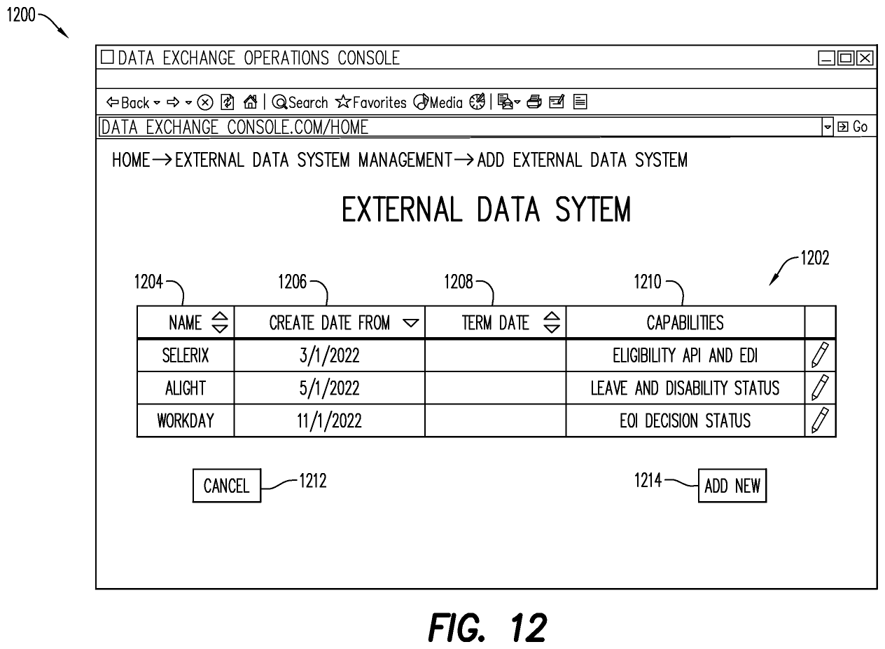

Selection of the “Cancel” button 1116 may result in the navigation back to the “External Data System Management” display 1000. Selection of the “Submit” button 1118 may result in the display of the “External Data System” display 1200 (FIG. 12) in S922. The “External Data System” display 1200 may include a table 1202 that represents an external data system data store that may be stored in the internal data store 404 according to some embodiments. The table 1202 may include all of the External Data Systems that have been added and are accessible for data exchange via the connection platform 408. The table 1202 may define fields 1204, 1206, 1208 and 1210 for each of the entries. The fields 1204, 1206, 1208 and 1210 may, according to some embodiments, include and specify: the External Data System name 1204, the Create Date 1206, a Termination date 1208 and a Capability 1210. The table 1202 may be created and updated, for example, based on information electronically received from various sources.

The External Data System name 1204 may be, for example the name of the software, and the Create Date 1206 may be the date the External Data System was added to the system. The Termination date 1208 may be the date the External Data System is no longer accessible via the connection platform 408. The Capability 1210 is the function provided by the External Data System.

The “External Data System” display 1200 may also include a “Cancel” button 1212 and an “Add New” button 1214. Selection of the “Cancel” button 1212 may return the user to the “External Data System Management” display 1000. Selection of the “Add New” button may return the user to the “New External Data System” display 1100.

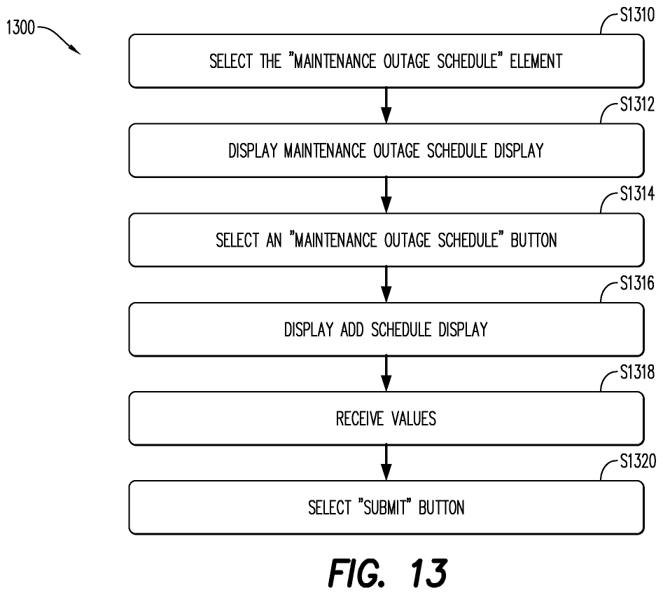

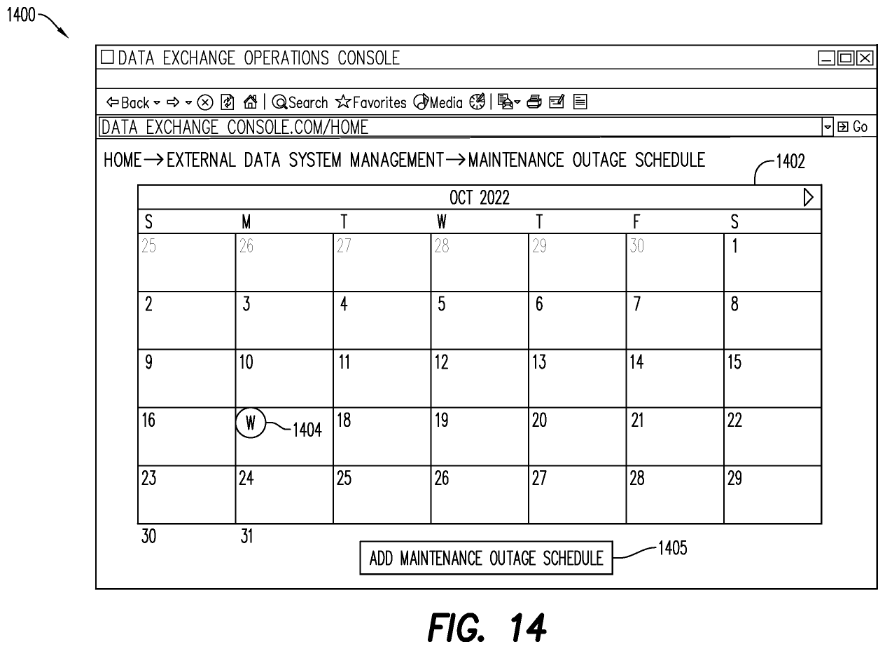

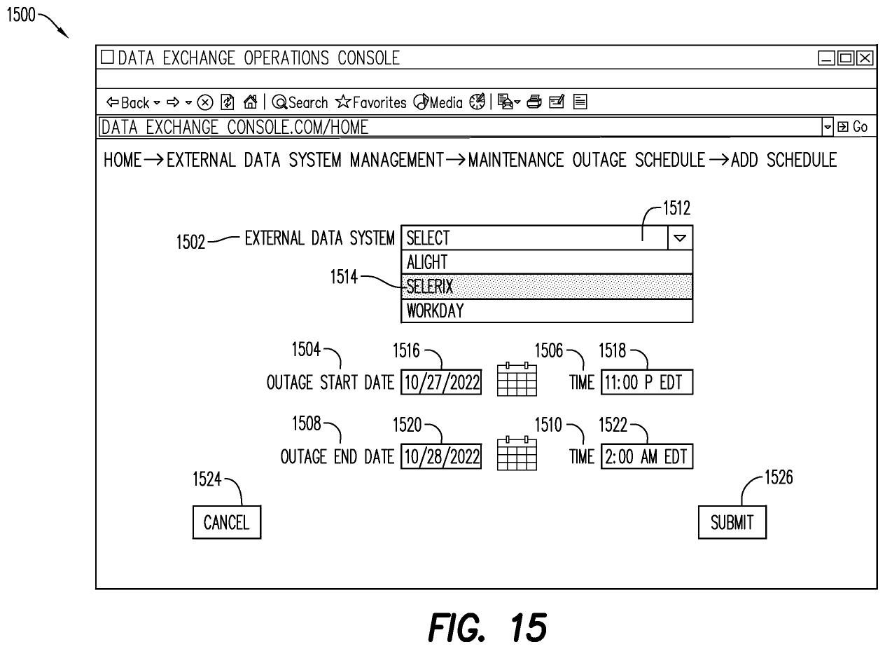

FIG. 13 provides a process 1300 to set up a Maintenance Outage Schedule for an External Data System. On occasions, an External Data System may schedule a period of time for an outage when the External Data System will be unavailable or may have a reduction in service in order to accommodate system upgrades, preventative maintenance or other suitable maintenance. The Maintenance Outage Schedule may be set up via the selection of the Maintenance Outage Schedule element 1004 on the “External Data System Management” display 1000 in S1310. Selection of the “Maintenance Outage Schedule” element 1004 may result in the display of a “Maintenance Outage Schedule” display 1400 (FIG. 14) in S1312. The “Maintenance Outage Schedule” display 1400 may include a calendar 1402 on which the already-scheduled outages are displayed. Here, an outage for an External Data System represented by the letter “W” is already scheduled 1404 to begin on Oct. 18, 2022. To set up a new schedule, an “Add Maintenance Outage Schedule” button 1405 is selected in S1314. Selection of the “Add Maintenance Outage Schedule” button 1405 may result in the display of an Add Schedule display 1500 (FIG. 15) in S1316. The Add Schedule display 1500 may include a plurality of parameters including, but not limited to, an External Data System parameter 1502, an Outage Start Date parameter 1504, an Outage Start Time parameter 1506, an Outage End Date parameter 1508, and an Outage End Time parameter 1510. Each parameter may have a user entry field 1512 associated therewith, where the user entry field 1512 may receive a value 1514/1516/1518/1520/1522, respectively, to describe the parameter. Values are received for the parameters in S1318. The External Data System parameter 1502 may include the names of the available External Data Systems for which the outage schedule is being created. Here the available External Data Systems may be Alight, Selerix and Workday. Selerix is the selected External Data System, as indicated by the highlight. The Outage Start Date parameter 1504 and Outage Start Time parameter 1506 may provide the date and time at which the outage is scheduled to begin. Here, the start date and time are Oct. 27, 2022 at 11:00 pm EDT. The Outage End Date parameter 1520 and Outage End Time parameter 1510 may provide the date and time at which the outage is scheduled to end. Here, the end date and time are Oct. 28, 2022 at 2:00 am EDT. The period of time for the outage, including the start date/time and end date/time may be referred to as a “Maintenance Outage Window.”

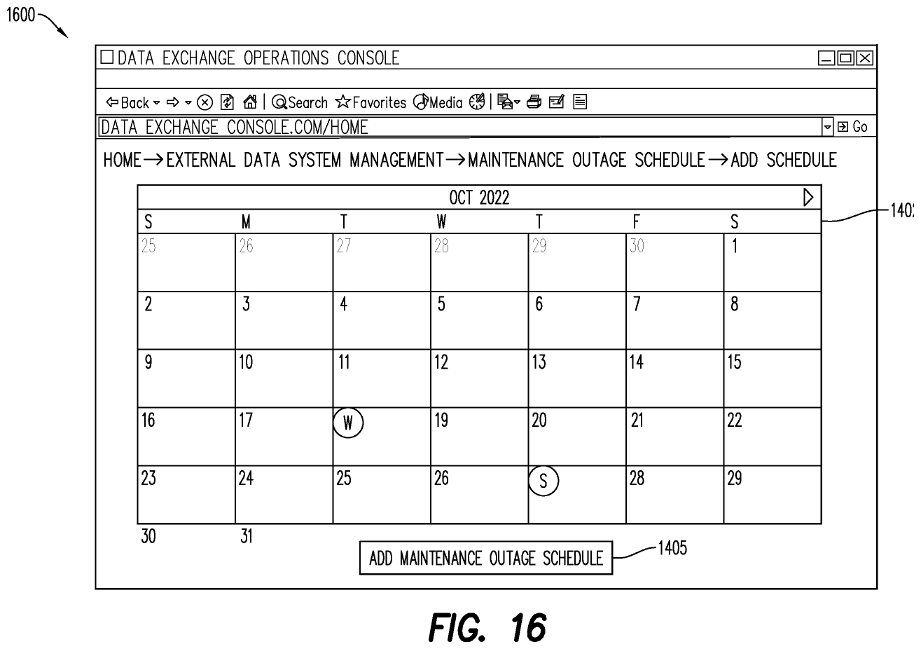

The “Add Schedule” display 1500 may also include a “Cancel” button 1524 and a “Submit” button 1526. Selection of the “Cancel” button 1524 may return the user to the External Data System Management display 1000. Selection of the “Submit” button 1526 may save the entered schedule to the internal data store 404. The “Submit” button 1526 is selected in S1320. Following selection of the “Submit” button 1526, an updated Maintenance Outage Schedule display 1600 is provided in FIG. 16 including the calendar 1402 with the newly added Maintenance Outage Schedule for the selected Selerix External Data System represented by the “S”. Here, the Maintenance Outage Schedule display 1600 includes a maintenance outage schedule for “W” on Oct. 18, 2022 and a maintenance outage schedule for “S” on Oct. 27, 2022.

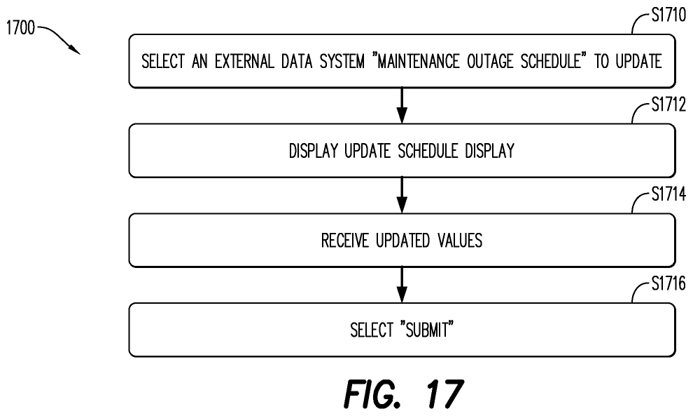

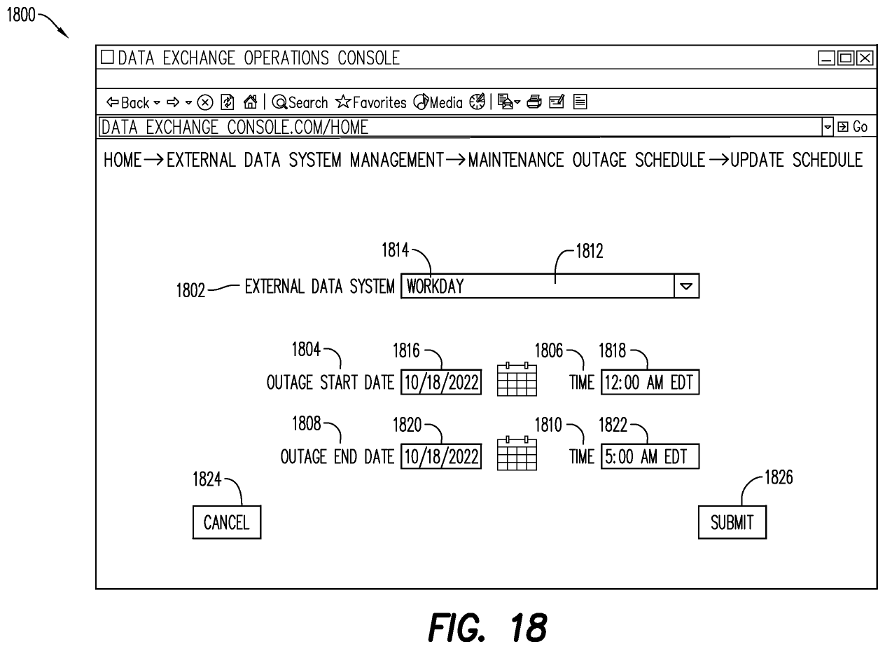

According to some embodiments, in addition to adding a schedule, an existing schedule may be updated, as described by process 1700 in FIG. 17. In S1710, a letter (e.g., “W” or “S” in this example) representing an External Data System for which a Maintenance Outage Schedule has already been scheduled is selected from the calendar 1402. The letter may be selected by any suitable selection manner (e.g., touch screen, double clicking with a cursor, etc.). Selection of the letter may result in the display of an Update Maintenance Outage Schedule display 1800 (FIG. 18) in S1712. The Update Maintenance Outage Schedule display 1800 may include a plurality of parameters including, but not limited to, an External Data System parameter 1802, an Outage Start Date parameter 1804, an Outage Start Time parameter 1806, an Outage End Date parameter 1808, and an Outage End Time parameter 1810. Each parameter may have a user entry field 1812 associated therewith, where the user entry field 1812 may receive a value 1814/1816/1818/1820/1822, respectively, to describe the parameter. In one or more embodiments, the user entry fields 1812 may be pre-populated with the values from the Add Schedule display 1500. Additionally, the External Data System parameter 1802 may be pre-populated with the External Data System represented by the letter selected in S1710. Here, the “W” was selected in S1710, and the “Workday” External Data System value is pre-populated in the External Data System parameter 1802. Values are updated for the parameters in S1714.

The Update Maintenance Outage Schedule display 1800 may also include a “Cancel” button 1824 and a “Submit” button 1826. Selection of the “Cancel” button 1824 may return the user to the External Data System Management display 1000. In some embodiments, selection of the “Cancel” button 1824 may return the user to the Maintenance Outage Schedule display 1400/1600. Selection of the “Submit” button 1826 may save the updated schedule to the internal data store 404. The “Submit” button 1826 is selected in S1816.

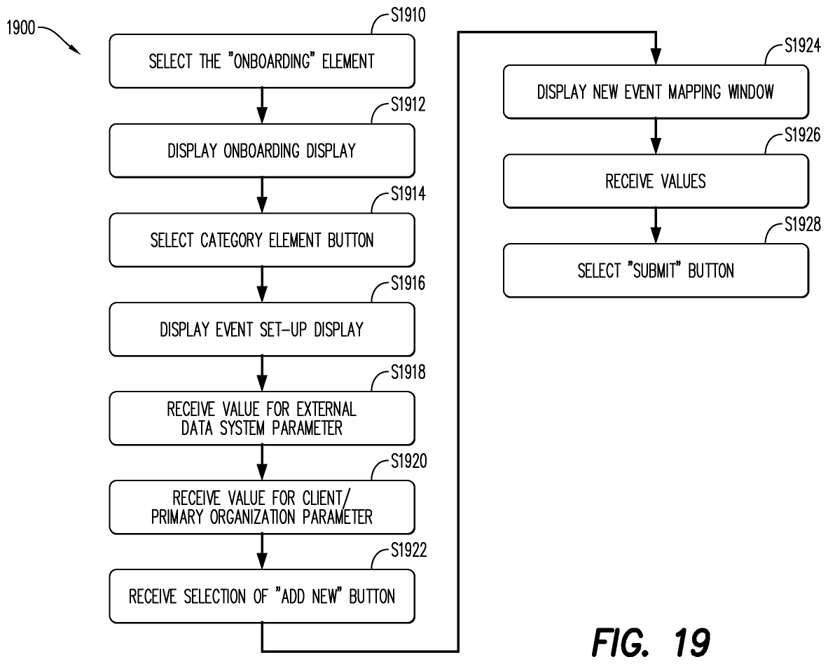

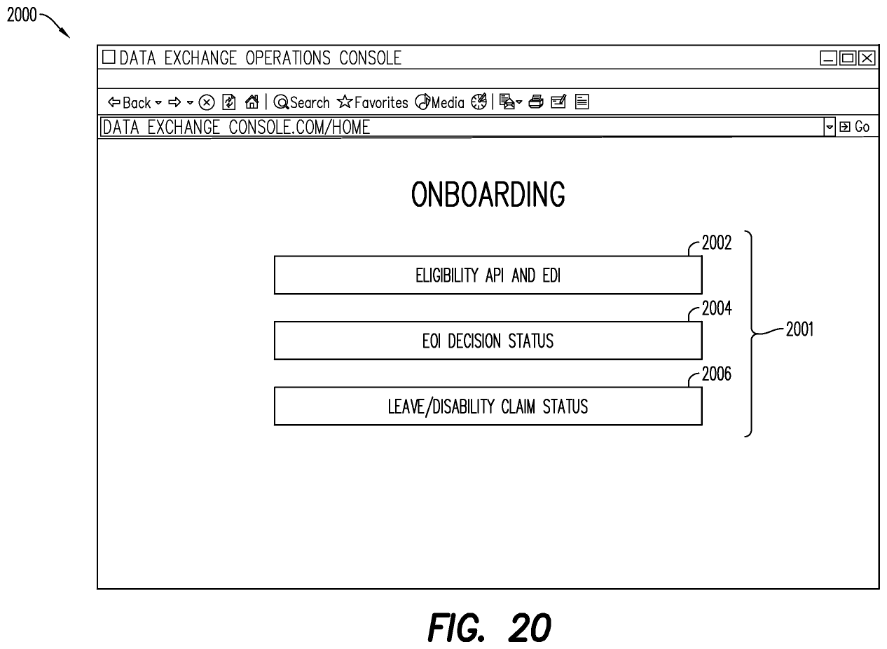

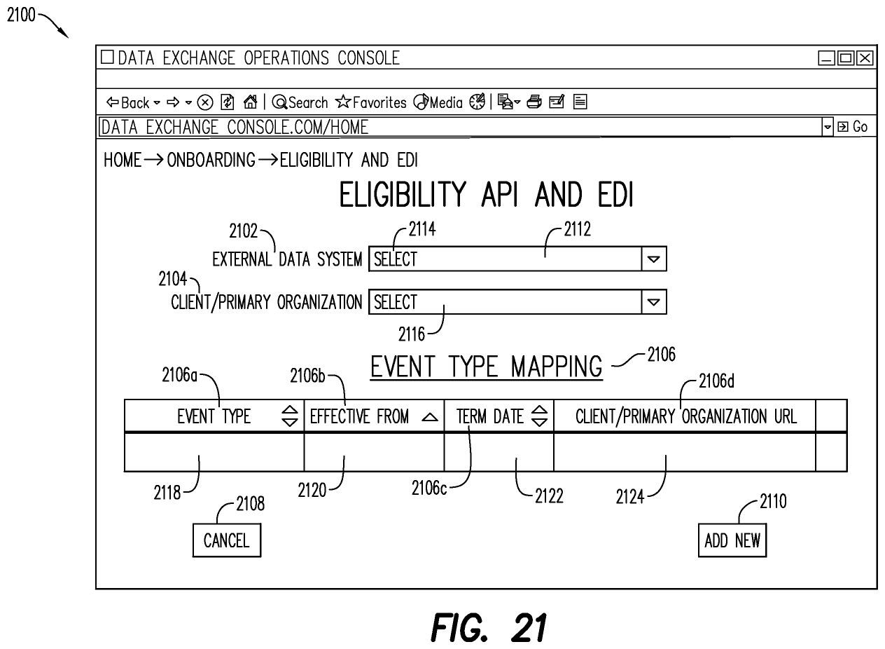

FIG. 19 provides a process 1900 to onboard/set-up an event that may include the exchange of data via the connection platform 408. As used herein, an “event” may refer to any instance or transaction that may cause or result in the exchange of data. As a non-exhaustive example, an event may be setting up a disability claim or entering a leave of absence into the system. As another non-exhaustive example, an event may be one or more employees of the primary organization completing enrollment, and the flow of this data into the internal data system via the external data system. The event may be onboarded via the selection of the “Onboarding” element 506 on the Data Exchange Operations display 500 in S1910. Selection of the “Onboarding” element 506 may result in the display of an Onboarding display 2000 (FIG. 20) in S1912. The Onboarding display 2000 may include a plurality of selectable category elements (“event category”) 2001. Each selectable element may represent a category/type of an event that will be onboarded. Here the elements are “Eligibility API and EDI” element 2002, an “EOI Decision Status” element 2004, and a “Leave/Disability Claim Status” element 2006. However, any suitable elements may be included. The elements available for selection may be provided based on the internal data systems, external data systems and primary data systems. In S1914, a category element 2001 is selected. Here, the Eligibility API and EDI element 2002 button is selected. Selection of the category element 2001 may result in the display of an “Event Set-Up” display 2100 (FIG. 21) in S1916.

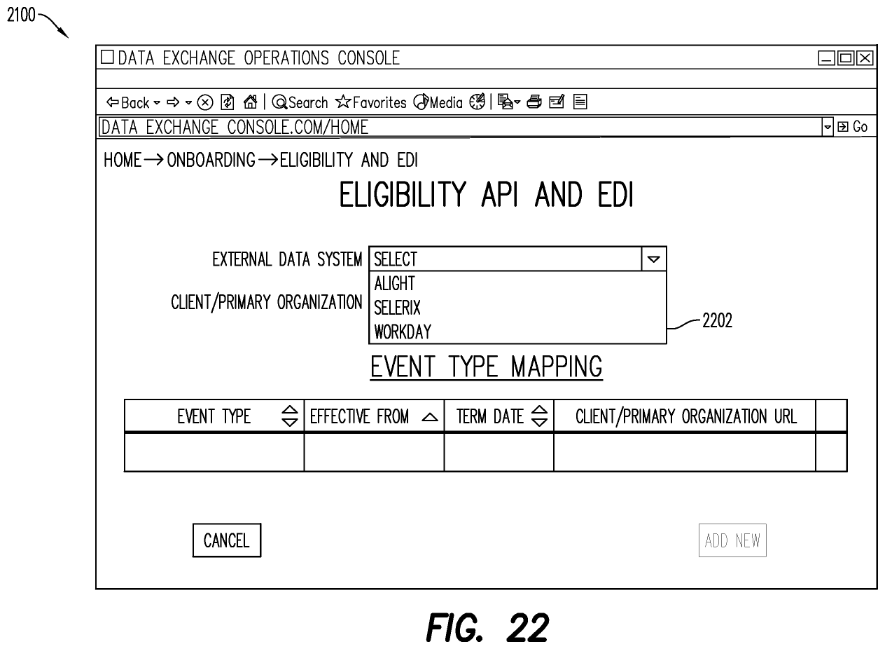

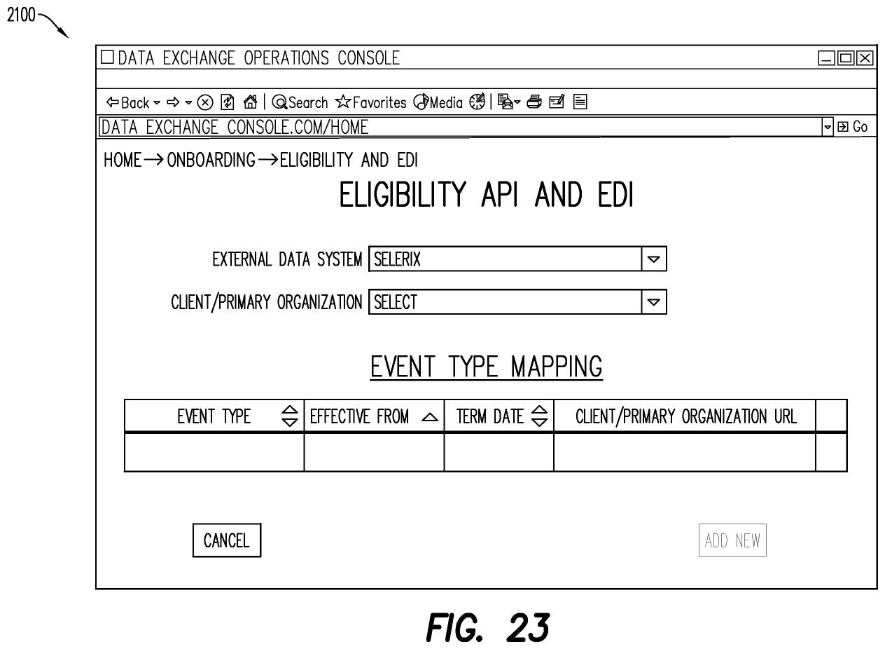

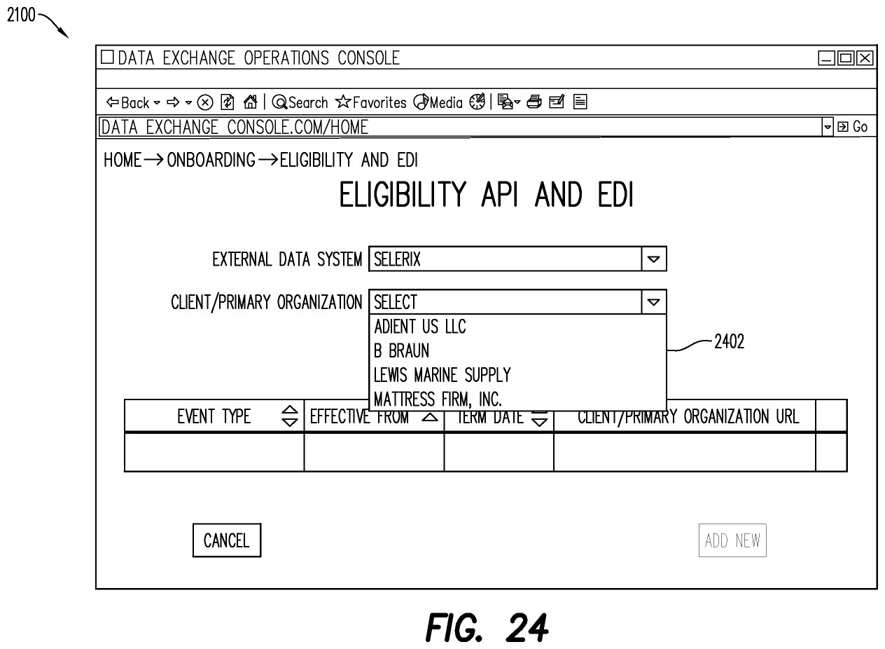

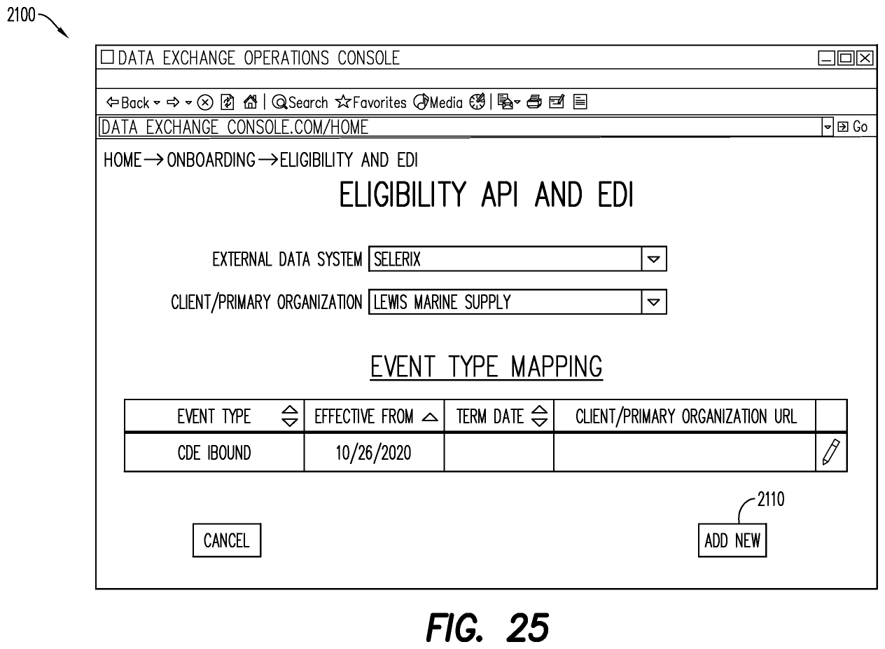

The “Event Set-Up” display 2100 may include a plurality of parameters including, but not limited to, an External Data System parameter 2102, a Client/Primary Organization parameter 2104, an Event Type Mapping table parameter 2106, a Cancel button 2108 and an Add New button 2110. The Event Type Mapping table parameter 2106 may include a plurality of parameters, including but not limited to, Event Type 2106a, Effective From 2106b, Term Date 2106c and External Data URL 2106d. Each parameter may have a user entry field 2112 associated therewith, where the user entry field 2112 may receive a value 2114/2116/2118/2120/2122/2124, respectively, to describe the parameter. The Event Type 2106a may be, for example, the category of event like a Leave of Absence, and the Effective From 2106b may indicate the start date of the event. The Term Date 2106c may be the end date of the event. The External Data URL 2106d may be the URL address to send the data to from the connection platform 408. In S1918 a value 2114 is received for the External Data System parameter. The value 2114 may be selected from a drop-down menu 2202, as shown in FIG. 22. In some embodiments, the selectable elements provided in the drop-down menu 2202 may be based on the type of category element 2001 selected in S1914, as particular External Data Systems may track, and therefore want to onboard, particular events. Continuing with the non-exhaustive example herein, for the Eligibility API and EDI category, the External Data Systems available for selection in S1918 are “Alright, Selerix and Workday” and “Selerix” is selected as shown in FIG. 23. Then in S1920, a value 2116 is received for the Client/Primary Organization parameter 2104. The value 2116 may be selected from a drop-down menu 2402, as shown in FIG. 24. In some embodiments, the selectable elements provided in the drop-down menu 2402 may be based on the selected External Data System, as particular External Data Systems may exchange data with particular primary organizations/clients. In other embodiments, the selectable elements provided in the drop-down menu 2402 may be based on the cumulative Client/Primary organizations added and saved during the Add Entity process described above. Continuing with the non-exhaustive example herein, the Client/Primary Organizations available for selection in S1920 are “ADIENT US LLC”, “B Braun”, “Lewis Marine Supply” and “Mattress Firm, Inc.” and “Lewis Marine Supply” is selected as shown in FIG. 25.

After selection of the External Data System and the Client/Primary organization, the Event Type Mapping Table parameter may be pre-populated with events that have already been created for these parties. For example, as shown in FIG. 25, after selection of Selerix as the External Data System and Lewis Marine Supply as the Client/Primary Organization, the Event Type Mapping table is populated with an Event Type 2106a of “CDE IBound” and an Effective From 2106b of “Oct. 25, 2020.” It is noted that some entries in the Event Type Mapping table may not include values for all of the parameters. For example, here, there is no value for Term Date and Client/Primary Organization URI for the event type “CDE IBOUND” for the selected External Data System “Selerix” and Client/Primary Organization “Lewis Marine Supply”.

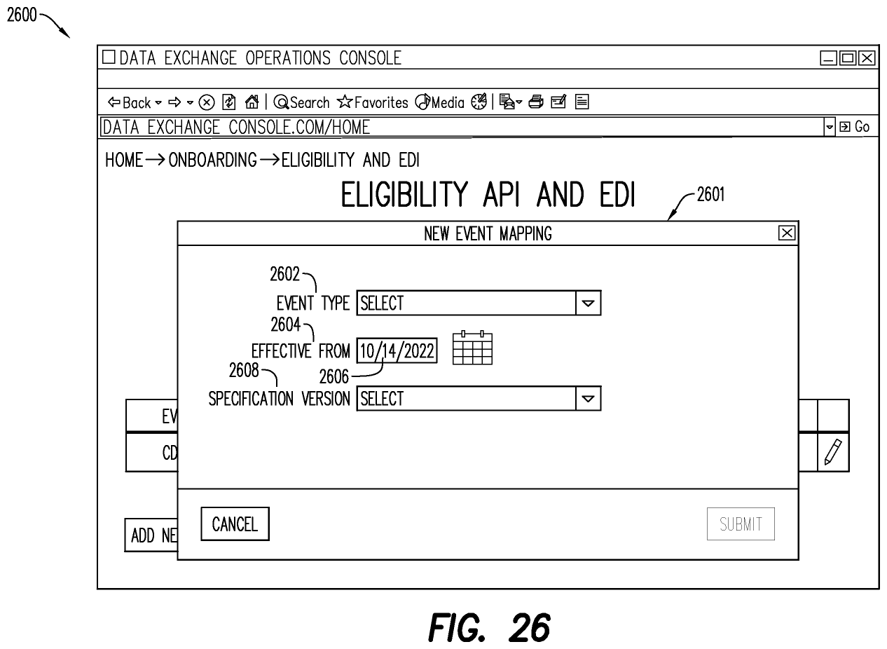

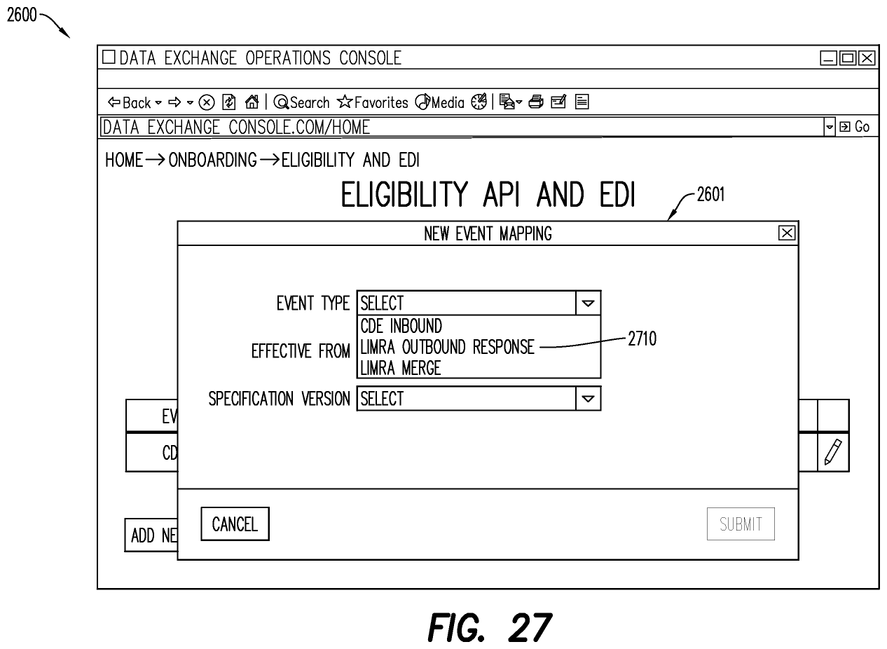

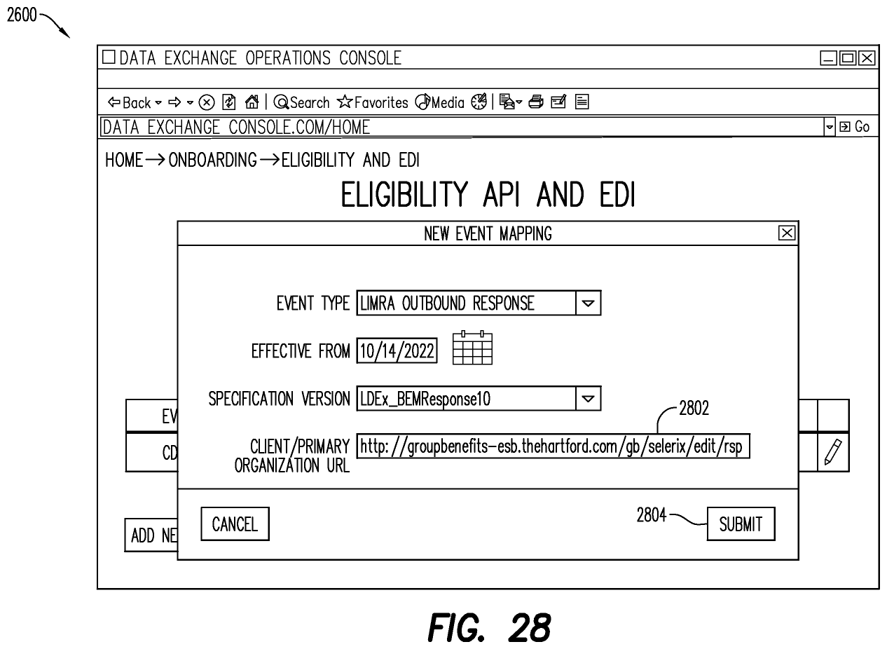

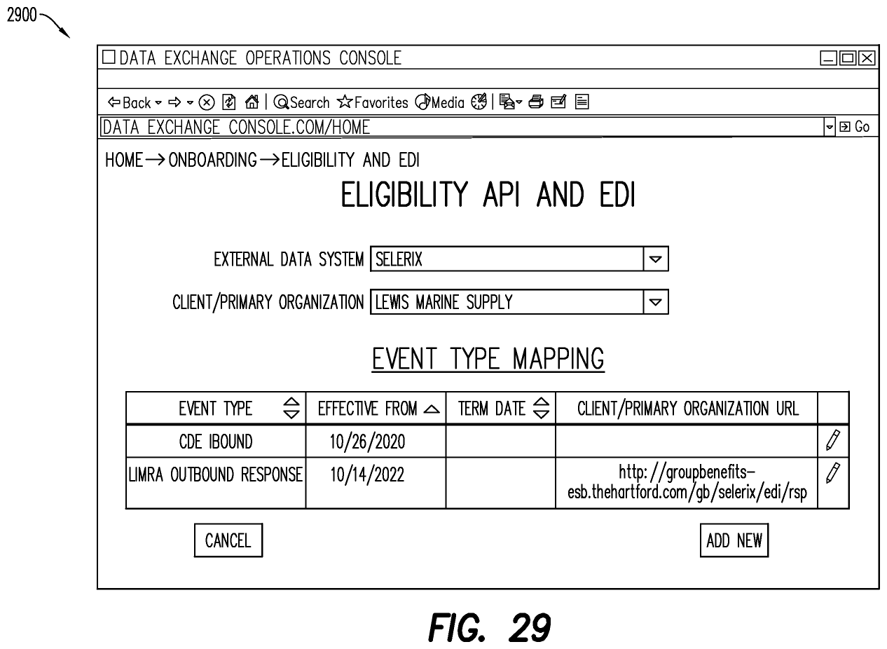

To add a new event, the “Add New” button 2110 is selected in S1922. Selection of the “Add New” button 2110 may result in a display 2600 (FIG. 26) of the New Event Mapping window 2601 in S1924. It is noted that while the New Event Mapping shown herein is displayed as a pop-up window, other suitable displays may be used. The New Event Mapping window 2601 may include a plurality of parameters, including but not limited to, Event Type 2602, Effective From 2604, and Specification Version 2604. The Event Type 2602 and Effective From 2604 parameters may map to the Event Type 2106a and Effective From 2106b parameters, respectively. Values for the parameters may be received in S1926. The values may be received from a calendar, drop-down or entered via a text-entry field. The user may select an effective from date value 2606 from a calendar icon, for example, as shown in FIG. 26. Here, the selected effective from value is “Oct. 14, 2022”. The user may also select an Event Type value 2710 from a drop-down list, as shown in FIG. 27. Here, the selected Event Type is “LIMRA OUTBOUND RESPONSE”. In some embodiments, selection of the Event Type may result in the pre-population of the Specification Version 2608 and the inclusion of a Client/Primary Organization URI 2802 in the New Event Mapping window 2601, as shown in FIG. 28. It is noted that the Specification Version 2608 may also be selected from a drop-down menu or entered via a text-entry field. The Client/Primary Organization URL 2802 may map to the Client/Primary Organization URI parameter in the Event Type Mapping Table parameter. Then in S1928 the “Submit” button 2804 is selected. Selection of the “Submit” button 2804 may save the new event to the internal data store 404 as an event record 3154 (FIG. 31) and may display the new event in the Event Type Mapping Table as shown in the display 2900 in FIG. 29. The event may be an artifact. As used herein, an artifact is a complex and dependent data object that may either refer to preconfigured parameters (e.g., import parameters) or may refer to dynamic parameters/configurations (e.g., transactional data, export parameters, language settings, message formats). The event record may include the export selected by the mapping (e.g., the output/results) as well as data points indicating configurations, transactional data and import parameters. The event record 3154 may map an external data system 108 to a particular endpoint for a particular event/transaction. Continuing with the non-exhaustive example, the Event Type Mapping Table now includes Event type “LIMRA OUTBOUND RESPONSE.”

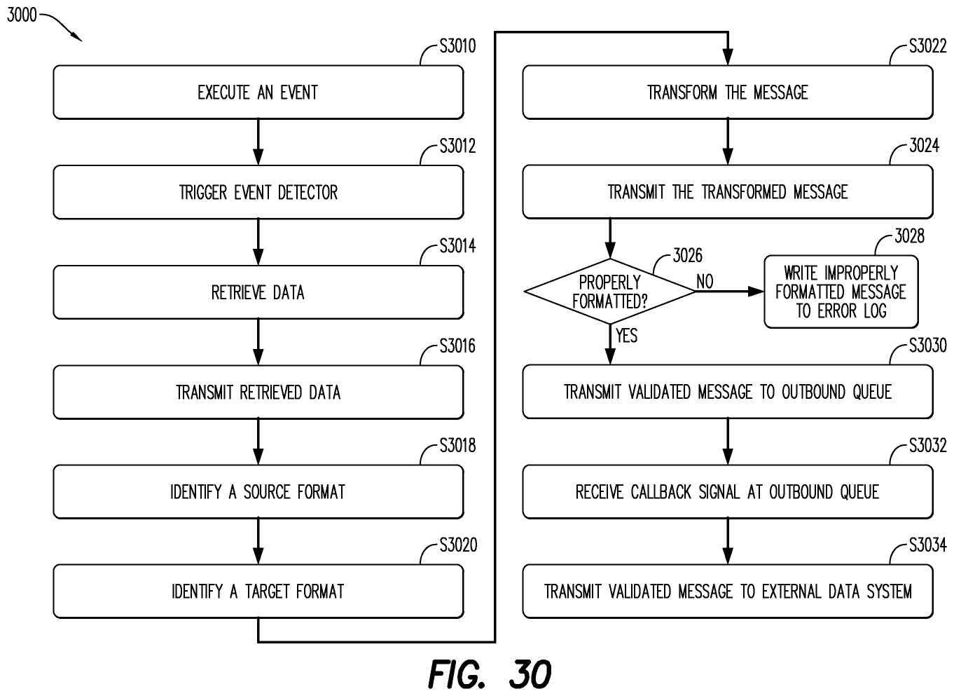

FIGS. 30 and 31 provides a process 3000 and block diagram 3100 to exchange data between the internal data system 410 and the external data system 412 via the connection platform 408.

FIG. 31 provides a more detailed high-level block diagram of a system architecture 3100, and in particular the connection platform 408, in accordance with some embodiments. As before, the connection platform 408 receives data 3101 from internal data systems 110 of the Secondary Organization 106 and outputs data 3103 to the external data system 108, as will be described further below.

The Secondary Organization 106 may include an event detector 3150 and a Message Publisher 3152. The event detector 3150 may identify the occurrence of a given event, as defined by an event record 3154, for example. The event detector 3150 may transmit, via the Message Publisher 3152, a message of associated data 3101 including the type of detected event (e.g., object and operation) as well as a data key required for the connection platform 408 to retrieve the event data from the internal data system 110. The event data may include data used in the execution of the event. Non-exhaustive examples of event data are an employee identifier, an event start date, an event end date and an event type. In some embodiments, the message of associated data 3101 may be sent in real time or near-real-time versus conventional methods that often use batch cycles to transmit the detected data at a post-real-time time.

The connection platform 408 may include a plurality of containers 3102, each containing a containerized application. Containerizing an application may package the application with its dependencies and some necessary services. The containerized applications include, but are not limited to, a Subscriber application 3108, a Transformation Manager application 3110, a Schema Validator application 3112 and a Callback API Client application 3114. The Subscriber application 3108 may register or subscribe to a particular event such that the Subscriber application 3108 is notified when the triggering event occurs. The event may be a claim update 3116, or any other suitable event. Then when the triggering event occurs, another code may be executed in response to detection of the triggering event.

The Transformation Manager application 3110 may transform a first message format to a second message format. In one or more embodiments, as part of the Event Type Mapping, the connection platform 408 may identify a message format for each of the parties linked to the event. For example, the connection platform may identify a first message format (e.g., XML, JSON, etc.) for a source data system and a second message format (e.g., JSON, XML, etc.) for a target data system. The first message format and the second message format may be a same format or a different format. In some embodiments, the Transformation Manager application 3110 may transform the message format of the source data (e.g., the first/source message format) to a suitable message format for target data (e.g., the second/target message format) to be received by the target party. The Transformation Manager application 3110 may include a plurality of adapters 3118, where each adapter is included for a respective source format. The adapter 3118 may be invoked once the connection platform 408 determines the source format and the target format are different by comparing the formats. The adapter 3118 may analyze each element in the source format (e.g., XML tags, for example) and map those elements and attributes to corresponding elements in the target format. The adapter 3118 may then generate a transformed message 3120 by replacing the elements in the source format with the corresponding mapped elements and attributes in the target format.

The Schema Validator application 3112 may receive the transformed message 3120 and determine whether the transformed message complies with a previously supplied schema 3122 defined for that message format with respect to syntactical correctness or structure of the format of the message block.

The internal database 3104 may also include an outbound queue 3124. After validation, the transformed message may be a transformed validated message 3123 (“validated message”) that may be pushed to the outbound queue 3124, where any suitable queuing service may receive the validated message and transmit it to the Callback API client application 3114. In a case enough resources are available, the validated message may be transmitted immediately. In a case there are insufficient resources, the validated message may be kept in the outbound queue 3124 and once resources are freed, the queueing service may retry transmitting the transformed validated message.

The Callback API Client application 3114 provides a callback to signal the Outbound Queue 3124 to transmit the validated message to the External Data System 108.

The validated message 3123 may be transmitted to the External Data System 108 via a Security Layer 3126. The Security Layer 3126 may include Basic Auth/Two-Way SSL (SOAP), DataPower, and OAuth/One-Way SSL (SOAP).

Prior to the start of the process 3000, an event is onboarded, as described above with respect to FIG. 19. As a non-exhaustive example, for FIG. 30, the event may be a Leave of Absence transaction. After the event is onboarded, the event is stored as an event record 3154 in the Internal database 3104. In one or more embodiments, after the event record 3154 is created, the Subscriber application 3108 may subscribe or register to be notified when the event occurs (e.g., event update 3116). In this example, the Subscriber application 3108 subscribes to be notified when a Leave of Absence transaction is executed.

Initially, at S3010 an event is executed. The event may be executed by an internal data system 110. Continuing with the Leave of Absence example, an employee of the Primary Organization 102 indicates to the Secondary Organization 106 that the employee needs to submit a request for a leave of absence. For example, the employee may submit information to the Secondary Organization 106 regarding their request through a phone center or self-service portal. The submitted information may include employee-specific data that identifies the employee, and may also include data related to the request. The request, including the submitted information, may be routed to and received by the appropriate internal data system 110. The internal data system 110 may generate a new or updated claim and/or a new or updated Leave of Absence transaction. The generated claim/transaction at the internal data system 110 may be the executed event. The generation of the claim/transaction event may trigger the event detector 3150 in S3012 to transmit the message of associated data (“event message”) 3101 notifying the Subscriber application 3108 via the Message Publisher 3152 of the executed event. The event message 3101 may include the event data, as described above.

Then in S3014 the Subscriber application 3108 may retrieve data, including the data in the event type mapping table parameter 2106 from the event record 3154 for that event message. In some embodiments, the Subscriber application 3108 may use the event data to identify the client 2104 and event type 2106a, which may in turn be mapped to a particular event record 3154. As described above, the event record 3154 includes the External Data System or target that will receive notification of the event and associated event data from the connection platform 408. The Subscriber application 3108 may, as part of the retrieved data, retrieve the External Data System from the event record 3154.

Continuing with the example, the employee is an employee of the client “XYZ Corp.” and the event type is “Leave of Absence”. Using the client of “XYZ Corp” and the event type of “Leave of Absence”, the Subscriber application 3108 may identify event record “ABC” as mapped to these client/event type parameters.

The Subscriber application 3108 transmits the retrieved data and event message to the Transformation Manager 3110 in S3016. The event message and retrieved data may be transmitted via HTTPS/REST or via any other suitable protocol. Next in S3018, the Transformation Manager 3110 identifies a first format for the event message based on the current/source format of the event message as identified via comparison to a format table or other suitable identifier. In our example, the source format is XML. Then in S3020, the Transformation Manager 3110 identifies the second/target format for the event message based on the identified External Data System. In some embodiments, the message format for the External Data System is stored for that External Data System as part of the adding the External Data System process described above. In our example, the target format is JSON.

Next, in S3022, the Transformation Manager application 3110 transforms the event message from the source format to the target format (“transformed message”) 3120 via the appropriate adapter 3118. In our example, the Transformation Manager application—via the adapter 3118—for each XML tag element in the event message, maps those elements and attributes to the corresponding JSON element.

Then in S3024, the Transformation Manager application 3110 transmits the transformed message 3120 to the Schema Validator application 3112. The Schema Validator application 3112 determines whether the transformed message is properly formatted to the schema for the target in S3026, as described above.

In a case the transformed message is not properly formatted, an Error message is automatically generated, and the improperly formatted transformed message may be written to an error log 3156 in the internal database 3104 in S3028. The Error message may be automatically transmitted to an error support user via e-mail.

In a case the transformed message is properly formatted, the validated message 3123 is stored in the internal database 3104 and transmitted to the Outbound Queue 3124 in S3030. When the appropriate resources are available, the Callback API Client application 3114 provides a callback signal in S3032 to the Outbound Queue 3124. In response to the callback signal, the Outbound Queue 3124 transmits the validated message 3123 to the External Data System 108 in S3034 via the Callback API Client application 3114. In our example, the Leave of Absence event message for the employee may be received at a Payroll/Absence External Data System 108 of the External Organization 104 for further processing and updating of a record on behalf of the Primary Organization.

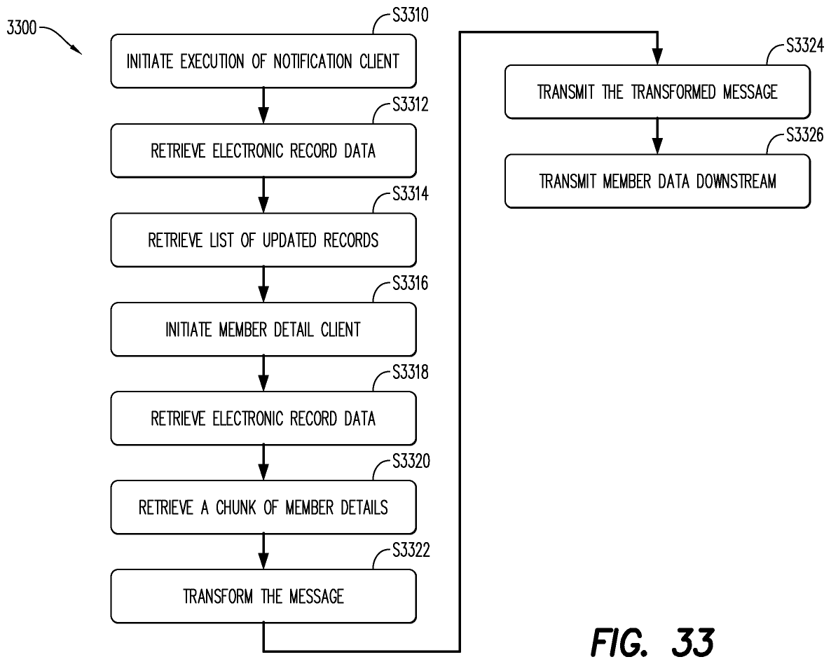

FIG. 32 provides another detailed high-level block diagram of a system architecture 3200, and in particular the connection platform 408, in accordance with embodiments. In the non-exhaustive example shown herein, the connection platform 408 receives data (e.g., employee data) of the Primary Organization 102 via the external data system 412, as will be described further below and with respect to the process 3300 described in FIG. 33. It is noted that the terms “member”, “employee” or “worker” may refer to the same entity, and in particular may refer to an employee. Identification of the member may also identify their dependents, beneficiaries, coverage elections, etc.

In embodiments, the connection platform 408 may include a scheduler 3202, a notification client 3204 and a member detail client 3206. The scheduler 3202 may be set by an administrator or other suitable party to trigger an event. In this case, the event may be the receipt of updated data from the external data system 108 in response to polling of the external data system 108 for at least one update to at least one employee data record of the Primary Organization 102. It is noted that the external organization 104 may provide the services they provide for the primary organization 102 to other organizations as well, as indicated by Primary Organization A 3208a, Primary Organization B 3208b and Primary Organization C 3208c. Each organization the external organization 104 provides these services for may be referred to as a “tenant”. It is noted that each tenant may select an API security pattern independent of other tenant API security pattern selections.

As with the process 3000 described above, initially, an event is executed. Prior to execution of the event at S3010, the scheduler 3202, based on the pre-defined schedule, may initiate execution of the notification client 3204 at S3310 shown herein at “1”. In response to this initiation, the notification client 3204 may access the internal data store 404 and retrieve electronic record data 413 stored therein, as described above, at S3312, shown herein at “2”. The electronic record data 413 may include external organization maintenance window/schedule 1004, primary organization outage window 3201, primary organization notification API call schedule 3203, primary organization member detail API call schedule 3205 and employee member chunk size 3207.

Next, at S3314 the notification client 3204 may call, via suitable API call, one or more external organization tenants 3208 to retrieve a list of one or more updated employee records identified by an employee ID at “3a” and “3b” shown herein. The call by the notification client 3204 may be based on at least one of the external organization maintenance window/schedule 1004, primary organization outage window 3201 and primary organization notification API call schedule 3203. It is noted that basing the call on the external organization maintenance schedule 1004 may avoid the system interacting with any tenants when the external data system is within a scheduled maintenance, which may avoid errors.

In response to receipt of the list of updated employee records, the scheduler 3202 may initiate the Member Detail Client 3206 in S3316 shown herein at “4”. Then, the Member Detail Client 3206 may access the internal data store 404 and retrieve electronic record data 413 stored therein, as described above, and indicated by “5” at S3318. At S3320, shown at “6a”/“6b,” the Member Detail Client 3206 may then make one or more API calls to each tenant based on the external organization maintenance window/schedule 1004, primary organization outage window 3201, primary organization member detail API call schedule 3205 and employee member chunk size 3207 to retrieve a chunk (i.e., subset of employees included on the list and identified by employee id) of member (i.e., employee) details. It is further noted that providing a configurable customer-specific schedule to retrieve a list of employee IDs with data changes and a separate configurable customer-specific schedule go retrieve detailed employee data may facilitate network usage and data flow as separate processes.

As with process 3000, after the connection platform 408 receives the member details, the Transformation Manager 3110 transforms the data and validates the transformed data at S3322. The Transformation Manager 3110 identifies a first format for the event message based on the current/source format of the event message (e.g., message including the member details) and identifies the second/target format for the event message based on the identified External Data System. Then the Transformation Manager application 3110 transforms the event message from the source format to the target format (“transformed message”) 3120 via the appropriate adapter 3118. Additionally, the Transformation Manager application 3110 may then transmit the transformed message 3120 to the Schema Validator application 3112. The Schema Validator application 3112 determines whether the transformed message is properly formatted to the schema for the target, as described above.

In a case the transformed message is not properly formatted, an Error message is automatically generated, and the improperly formatted transformed message may be written to an error log 3156 in the internal database 3104. The Error message may be automatically transmitted to an error support user via e-mail.

In a case the transformed message is properly formatted, the validated message 3123 is transmitted at S3324 to a Member Data Processor 3210 for further processing indicated by “7”. Then in S3326 the Member Data Processor 3210 may transmit the member data 3212 to one or more downstream systems indicated by “8”.

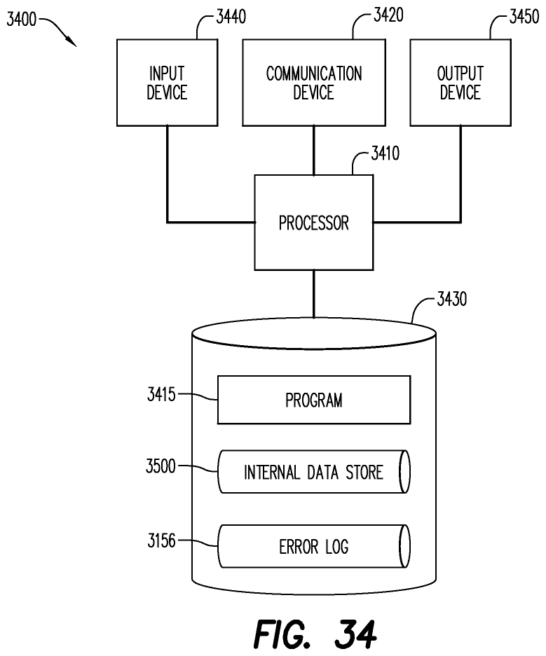

The embodiments described herein may be implemented using any number of different hardware configurations. For example, FIG. 34 illustrates an apparatus 3400 that may be, for example, associated with the system 400 described with respect to FIG. 4. The apparatus 3400 comprises a processor 3410, such as one or more commercially available Central Processing Units (“CPUs”) in the form of one-chip microprocessors, coupled to a communication device 3420 configured to communicate via a communication network (not shown in FIG. 34). The communication device 3420 may be used to communicate, for example, with one or more remote third-party business or economic platforms, administrator computers, insurance agent, and/or communication devices (e.g., PCs and smartphones). Note that communications exchanged via the communication device 3420 may utilize security features, such as those between a public internet user and an internal network of an insurance company and/or an enterprise. The security features might be associated with, for example, web servers, firewalls, and/or PCI infrastructure. The apparatus 3400 further includes an input device 3440 (e.g., a mouse and/or keyboard to enter information about data sources, add and configure parties, onboard events, etc.) and an output device 3450 (e.g., to output reports regarding predictions, recommendations, alerts, etc.).

The processor 3410 also communicates with a storage device 3430. The storage device 3430 may comprise any appropriate information storage device, including combinations of magnetic storage devices (e.g., a hard disk drive), optical storage devices, mobile telephones, and/or semiconductor memory devices. The storage device 3430 stores a program 3415 and/or a connection platform tool or application for controlling the processor 3410. The processor 3410 performs instructions of the program 3415, and thereby operates in accordance with any of the embodiments described herein. For example, the processor 3410 may receive identification and/or notification of a previously-onboarded event and automatically exchange data between the internal data system and the external data system in response to the identification and/or notification of the event. The processor 3410 can then update records to reflect information the exchanged data.

The program 3415 may be stored in a compressed, uncompiled and/or encrypted format. The program 3415 may furthermore include other program elements, such as an operating system, a database management system, and/or device drivers used by the processor 3410 to interface with peripheral devices.

As used herein, information may be “received” by or “transmitted” to, for example: (i) the apparatus 3400 from another device; or (ii) a software application or module within the apparatus 3400 from another software application, module, or any other source.

In some embodiments (such as shown in FIG. 34), the storage device 3430 further includes an internal data store 3500, and an error log 3156.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system comprising:
a plurality of internal data systems;
a plurality of external data systems;
a back-end application computer server, coupled to the plurality of internal data systems and the plurality of external data systems, the back-end application computer server including:
a computer processor, and
a computer memory, coupled to the computer processor, storing instructions that, when executed by the computer processor, cause the back-end application computer server to:
receive an event onboarding request;
receive selection of a first external data system of the plurality of external data systems and an event type; and
generate an event record based on the selected first external data system and the event type.

2. The system of claim 1, further comprising instructions that, when executed by the computer processor, cause the back-end application computer server to:
receive, from a first external data system of the plurality of data systems, an event, wherein the event is updated data.

3. The system of claim 2, further comprising instructions that, when executed by the computer processor, cause the back-end application computer server to, prior to receipt of the event:
initiate, by a scheduler, execution of a notification client;
identify electronic record data for the first external data system;
receive an indication of updated data at the first external data system;
initiate, by the scheduler, execution of a member detail client; and
receive the event in response to execution of the member detail client.

4. The system of claim 1, further comprising instructions that, when executed by the computer processor, cause the back-end application computer server to:
receive, from a first internal data system of the plurality of data systems, an event;
identify the event record mapped to the event;
identify the first external data system based on the event record;
transform a message format of the received event from a first format to a second format via a format-specific adapter; and
validate a data schema for the transformed message via a schema validator.

5. The system of claim 4, wherein the second format is accessible by the first external data system.

6. The system of claim 4, further comprising instructions that, when executed by the computer processor, cause the back-end application computer server to:
transmit, after validation, the transformed message to the first external data system; and
update a status of a record at the external data system based on the received transformed message.

7. The system of claim 1, wherein the event onboarding request includes selection of an event category.

8. The system of claim 7, wherein the event category is one of: i. Eligibility Application Programming Interface (API) and Electronic Data Interchange (EDI); ii. Health Status; and iii. claim Status.

9. The system of claim 4, wherein the back-end application computer server receives the event based on a subscription to the event at the first internal data system.

10. The system of claim 1, further comprising instructions that, when executed by the computer processor, cause the back-end application computer server to, prior to receipt of the event onboarding request:
receive an external data system onboarding request for a first external data system of the plurality of external data systems;
receive an external data system identifier for the first external data system and an external data system function for the first external data system;
create an external data system record of the first external data system; and
store the external data system record in the memory.

11. A method comprising:
receiving, from a remote user device, an event onboarding request;
receiving, by a computer processor of a back-end application computer server, selection of a first external data system of a plurality of external data systems and an event type; and
generating, by the computer processor of the back-end application computer server, an event record based on the selected first external data system and the event type.

12. The method of claim 11, further comprising:
receiving, from the first external data system of the plurality of data systems, an event, wherein the event is updated data.

13. The method of claim 12, further comprising, prior to receiving of the event:
initiating, by a scheduler, execution of a notification client;
identifying electronic record data for the first external data system;
receiving an indication of updated data at the first external data system;
initiating, by the scheduler, execution of a member detail client; and
receiving the event in response to execution of the member detail client.

14. The method of claim 11, further comprising:
receiving, from a first internal data system of a plurality of internal data systems, an event;
identifying the event record mapped to the event;
identifying a first external data system based on the event record;
transforming a message format of the received event from a first format to a second format via a format-specific adapter; and
validate a data schema for the transformed message via a schema validator.

15. The method of claim 14, further comprising:
transmitting, after validation, the transformed message to the first external data system; and
updating a status of a record at the external data system based on the received transformed message.

16. The method of claim 11, further comprising, prior to receipt of the event onboarding request:
receiving an external data system onboarding request for a first external data system of the plurality of external data systems;
receiving an external data system identifier for the first external data system and an external data system function for the first external data system;
creating an external data system record of the first external data system; and
storing the external data system record in a memory.

17. A non-transitory, computer-readable medium storing instructions that, when executed by a processor, cause the processor to:
receive an event onboarding request;
receive selection of a first external data system of a plurality of external data systems and an event type; and
generate an event record based on the selected first external data system and the event type.

18. The medium of claim 17 further comprising instructions that, when executed by the processor, cause the processor to:
initiate, by a scheduler, execution of a notification client;
identify electronic record data for the first external data system;
receive an indication of updated data at the first external data system;
initiate, by the scheduler, execution of a member detail client; and
receive an event in response to execution of the member detail client, wherein the event is updated data.

19. The medium of claim 17 further comprising instructions that, when executed by the processor, cause the processor to:
receive, from a first internal data system of the plurality of data systems, an event;
identify the event record mapped to the event;
identify the first external data system based on the event record;
transform a message format of the received event from a first format to a second format via a format-specific adapter; and
validate a data schema for the transformed message via a schema validator.

20. The medium of 19 further comprising instructions that, when executed by the processor, cause the processor to:
transmit, after validation, the transformed message to the first external data system; and
update a status of a record at the external data system based on the received transformed message.
